(19) United States
(12) Patent Application Publication
(10) Pub. No.: US 2006/0224419 A1
(43) Pub. Date: Oct. 5, 2006

(54) System and method for medication misuse prevention

(76) Inventors: Louis A. Servizio, Juno Beach, FL (US); Lynn Tress Servizio, Juno Beach, FL (US)

Correspondence Address: MCHALE & SLAVIN, P.A., 2855 PGA BLVD, PALM BEACH GARDENS, FL, 33410, US

(21) Appl. No.: 11/453,957

(22) Filed: Jun. 15, 2006

(51) Int. Cl. G06Q 10/00; G06Q 50/00

(52) U.S. Cl. 705/2

(57) ABSTRACT

A system and method of identifying patients with an increased risk for medication misuse as a result of their physical condition or inability to follow a prescription drug regimen. This is accomplished by an onsite evaluation of the patient, their physical condition and medication usage, including prescriptions, over the counter medications, herbals and food interactions, by a qualified individual. The results of this evaluation are provided to a database that generates a report comprising a patient's vital signs, medication interactions, prescription changes, prescription renewals, discontinued medications, evaluation of a patient's compliance with their medication regimen and education approved for to assist the patient with their compliance for review by the patient's primary care physician, additional physicians treating the patient, authorized organizations, such as HMOs, gardians or other authorized individual. With this knowledge the physician can identify a current or potential problem and can recommend changes to a patient's prescription drug regimen or education regarding drug regimens to correct the problem.

This invention relates to a system and method for the prevention of medication misuse. This includes monitoring the drugs that are prescribed for a patient, over the counter medications, herbals, foods interacting with medications their interaction with each other, and patient compliance with their prescribed drug regimen, education and electronic communication of results of the results to physicians within the home setting.

### BACKGROUND OF THE INVENTION

The beneficial actions of prescription drugs depend on the specific drug prescribed, the amount (dose) of the drug taken and the time-interval separating successive doses of the drug. As the average age of today's population increases the number of drugs prescribed per individual also increases. The medium number of prescriptions taken by elderly patients today is 14. If these are prescribed by more than one physician there is a substantial risk of adverse drug interactions. Also, many elderly patients become forgetful and do not stay with their prescribed drug regimen.

Every year, thousands of people die needlessly or make unnecessary visits to emergency rooms because they take medications with contraindications, or take incorrect, expired, or older medication dosages despite changes in their medical condition. One physician has no idea that the patient is being treated by another physician for another condition. The same physician prescribes separate medications for different diseases (e.g. asthma and diabetes) the have adverse affects. Dosages might have been changed, but the patient is taking whatever dosage is in their medicine cabinet. Patients have dozens of prescriptions that have expired or are narcotic. Patients are told by friends to buy “natural” remedies, not being aware that they interact with prescribed medications. The latest changes in the Medicare Prescription Plan, Part D, have exacerbat4ed this problem because medications that patients normally take will be substituted with unfamiliar ones, based on the formulary of the plan they choose.

### DESCRIPTION OF THE PRIOR ART

U.S. Pat. No. 6,822,554 to Vrijens et al. relates to a system and method of medication monitoring including analyzing the clinical consequences of variable patient compliance with their prescribed drug regimen. Also communicating to care givers and/or patients the compliance-dependent probabilities of two important transitions in the patient's health status: substantial improvement in the patient's health status and substantial deterioration in the patient's health status. Also intervening when appropriate to improve the patient's compliance. However, Vrijens et al. do not monitor the interaction of the different drugs which are prescribed for the patient, the over the counter medications, the herbals and the foods which interact with medications. Nor do they provide an assessment of the mental state, functional ability and cognitive ability of the patient as related to their compliance with their drug regimen.

U.S. Pat. No. 6,694,298 to Teagarden et al. relates to a computer assisted method of gathering a therapeutic history of a patient, creating a medication profile including patient demographics, patient's physician, current medications, medication use pattern, OTC medication useage, patient understanding of treatment goals, adverse affects, compliance history, medical/family history, hospitalization history, pertinent laboratory work, patient concerns and patient satisfaction assessment. The patient's physician is then contacted to verify current medications, discuss potential interventions, establish therapeutic goals, verify adverse drug reactions and discuss any compliance issues. Finally a summary letter is sent to the physician, a summary of therapy changes is sent to the patient, a call is made to the patient from the pharmacist and a health status survey is sent to the patient. However, Teagarden et al. do not provide for an assessment of the mental state, functional ability and cognitive ability of the patient as related to their compliance with their drug regimen. In addition Teagarden et al. do not send someone to the patient's residence to monitor the use of the prescribed medications, herbals, over the counter medications, and food which interact with medications. Further, Teagarden et al. do not provide for electronic communication of the results of the assessment or a follow-up of the patient's compliance with their medication regimen.

### SUMMARY OF THE INVENTION

The present invention relates to a system and method of identifying patients with an increased risk for medication misuse as a result of their physical condition or inability to follow a prescription drug regimen. This is accomplished by an onsite evaluation of the patient, their physical condition and medication usage, including prescriptions, over the counter medications, herbals and food interactions, by a qualified individual. The results of this evaluation are provided to a database that generates a report comprising a patient's vital signs, medication interactions, prescription changes, prescription renewals, discontinued medications, evaluation of a patient's compliance with their medication regimen and education approved for to assist the patient with their compliance for review by the patient's primary care physician, additional physicians treating the patient, authorized organizations, such as HMOs, guardians or other authorized individual. With this knowledge the physician can identify a current or potential problem and can recommend changes to a patient's prescription drug regimen or education regarding drug regimens to correct the problem.

Accordingly, it is an objective of the instant invention to identify patients at increased risk for medication misuse and provide immediate, appropriate and expeditious corrective action on the part of physicians and patients.

It is a further objective of the instant invention to provide an in home inventory and review of medications, including prescriptions, over the counter, herbals and nutritional medications to establish a database from which medication misuse can be determined and corrective action recommended.

It is yet another objective of the instant invention to provide an in home service to determine expired medications, inappropriate medications, inappropriate dosages, missing medications and observation of side effects of medications taken, prescriptions, over the counter medications, herbals, and foods which interact with medications.

It is still yet another objective of the invention to provide an assessment of the mental state, functional ability and cognitive ability of a patient to comply with their prescribed drug regimen and/or therapy including a follow-up medical evaluation which includes a psychiatric evaluation as required.

It is a still further objective of the invention to assure that the patient is complying with their prescribed drug regimen and/or therapy.

It is yet still a further objective of the invention to provide a psychological evaluation, employing standardized tests, designed to evaluate or eliminate the potential for addictive behaviors, general level of functioning and abuse of existing prescriptions or illegal drugs at the time of the patient's assessment. If the test scores indicate there are significant risk factors, then a psychological/ mental health evaluation will be requested and scheduled.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a flowchart of the Medication Misuse Prevention Service (MMPS);

FIG. 2 is a continuation of the MMPS flowchart;

FIG. 3 is the a menu for patient information;

FIG. 4 is a menu for the identification of a patient's medications;

FIG. 5 is a the menu of FIG. 4 with additional information included;

FIG. 6 is the main menu for new problems;

FIG. 7 is the menu of FIG. 4 including additional information;

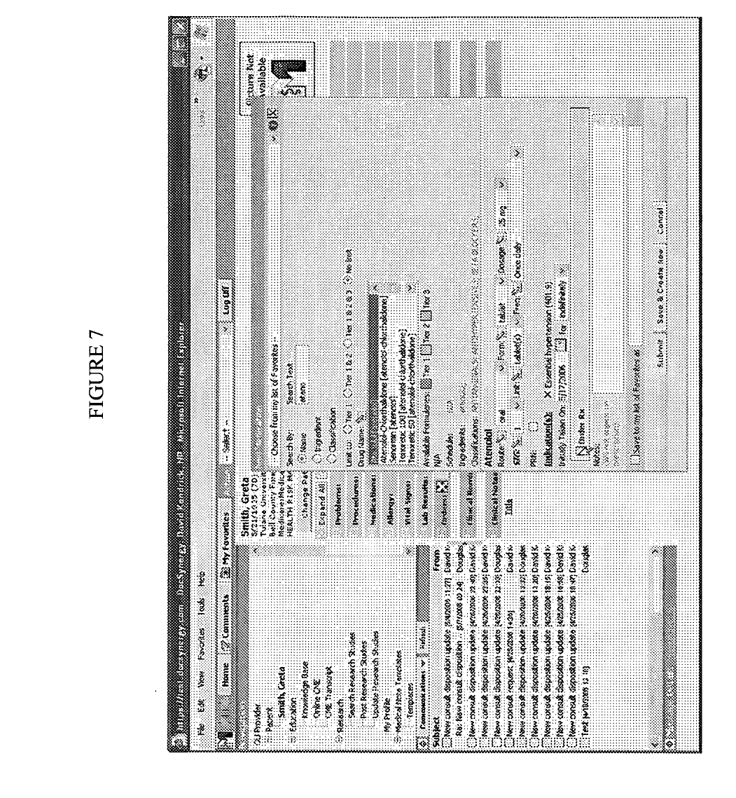

FIG. 8 is the menu of FIG. 4 including a prescription for medication;

FIG. 9 is the menu of FIG. 4 including information regarding another medication;

FIG. 10 is the menu of FIG. 9 including a prescription;

FIG. 11 is the menu of FIG. 9 wherein a drug interaction warning appears;

FIG. 12 is the menu of FIG. 4 including information regarding another medication;

FIG. 13 is the menu where a new medical condition information is entered;

FIG. 14 is the menu of FIG. 12 including additional information;

FIG. 15 is the menu of FIG. 12 including additional information;

FIG. 16 is the menu for entering information related to existing problems;

FIG. 17 is the menu of FIG. 4 including a prescription for a medication;

FIG. 18 is a menu for the review of medications;

FIG. 19 is the same menu as in FIG. 18;

FIG. 20 is the menu of FIG. 18 including existing medical conditions;

FIG. 21 is the main menu for entering information regarding a patient's health and living conditions;

FIG. 22 is a menu for entering information regarding a patient's medical history;

FIG. 23 is the menu of FIG. 22 including additional information;

FIG. 24 is the menu of FIG. 22 including additional information;

FIG. 25 is the menu of FIG. 22 including additional information;

FIG. 26 is the menu of FIG. 25 including additional menus for providing information;

FIG. 27 is the menu of FIG. 25 including additional information;

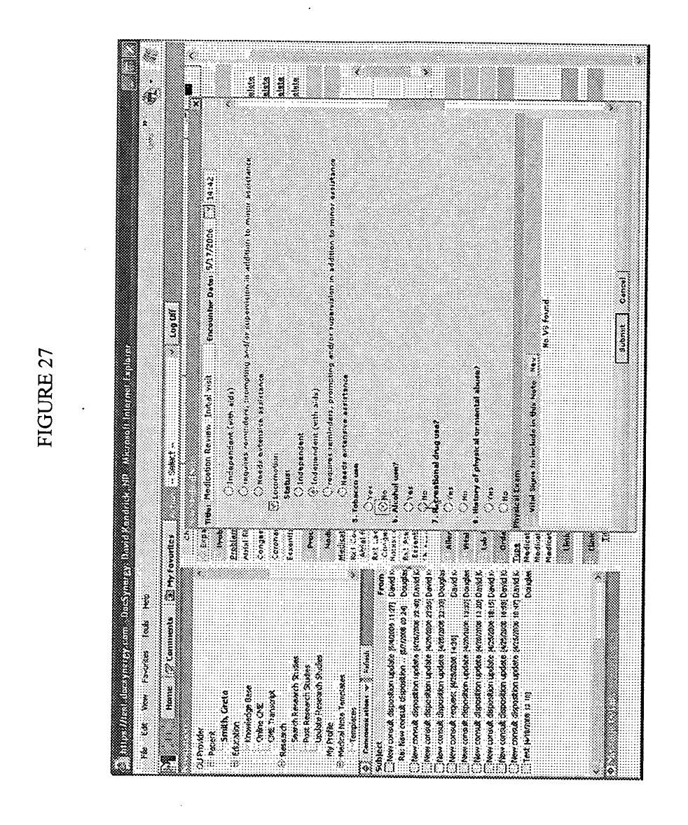

FIG. 28 is the menu of FIG. 25 including additional information;

FIG. 29 is the menu for entering a patient's vital signs;

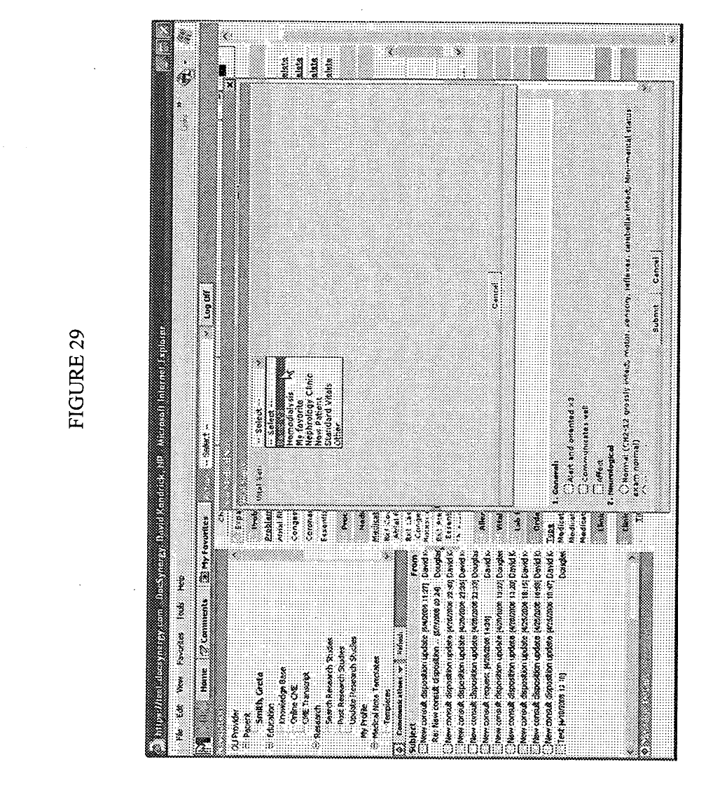

FIG. 30 is the menu with a patient's vital signs information entered;

FIG. 31 is the menu of FIG. 28 with a patient's vital signs information entered;

FIG. 32 is the menu of FIG. 25 with additional information;

FIG. 33 is the menu of FIG. 25 with additional information;

FIG. 34 is the menu of FIG. 25 with drug interaction information;

FIG. 35 is the menu of FIG. 25 with drug interaction information;

FIG. 36 is the menu of FIG. 25 with drug compliance information;

FIG. 37 is the menu of FIG. 25 with drug compliance information;

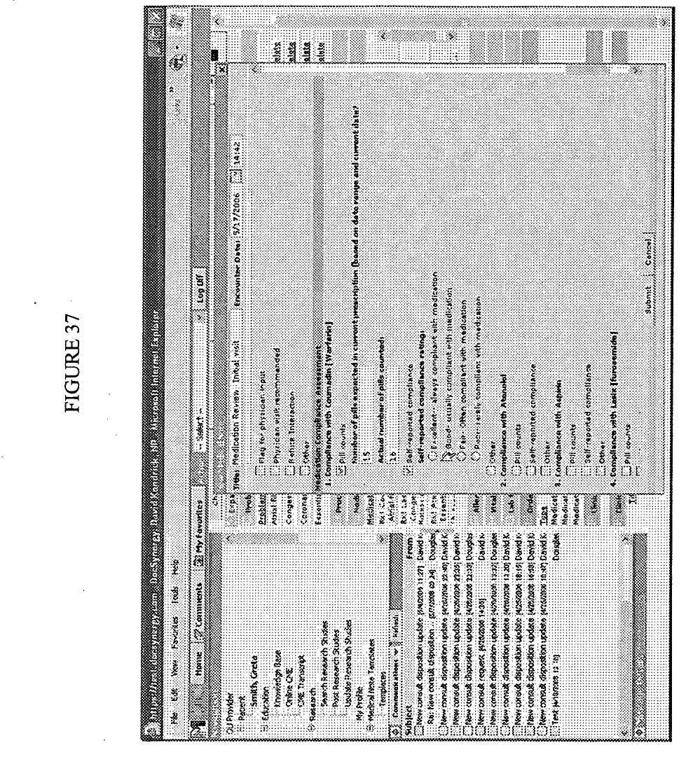

FIG. 38 is the menu of FIG. 25 with drug compliance information;

FIG. 38 is the menu of FIG. 25 with drug compliance information;

FIG. 40 is the menu of FIG. 25 with medication disposition information;

FIG. 41 is the menu of FIG. 25 with a summary of a patient's living conditions;

FIG. 42 is the menu of FIG. 25 with a summary of a patient's medications;

FIG. 43 is the menu of FIG. 25 with a summary of a patient's medical problems;

FIG. 44 is the menu of FIG. 25 including a patient's vital signs information;

FIG. 45 is the menu of FIG. 25 including drug interaction information;

FIG. 46 is the menu of FIG. 25 including medication compliance information;

FIG. 47 is the menu of FIG. 25 including a patient's medical conditions and medications; and

FIG. 48 is the menu of FIG. 25 including new prescriptions for a patient's medications.

### DETAILED DESCRIPTION OF THE INVENTION

The medication misuse prevention service of the present invention is a system and method designed to establish a medical and therapeutic history of a particular patient. From the information contained in this history a qualified individual can establish if a particular patient presents an increased risk for medication misuse or adverse medication interaction effects. If the patient is considered to be “at risk” then immediate, appropriate and expeditious corrective action can be taken on behalf of the patient's physician and/or patient. This corrective action will prevent needless deaths and costly emergency medical treatments associated with adverse drug events. The prevention service of the instant invention accomplishes this by utilizing the latest technology in electronic medical records; drug interaction data bases; electronic communications and a medical staff authorized to prescribe pharmaceutical drugs.

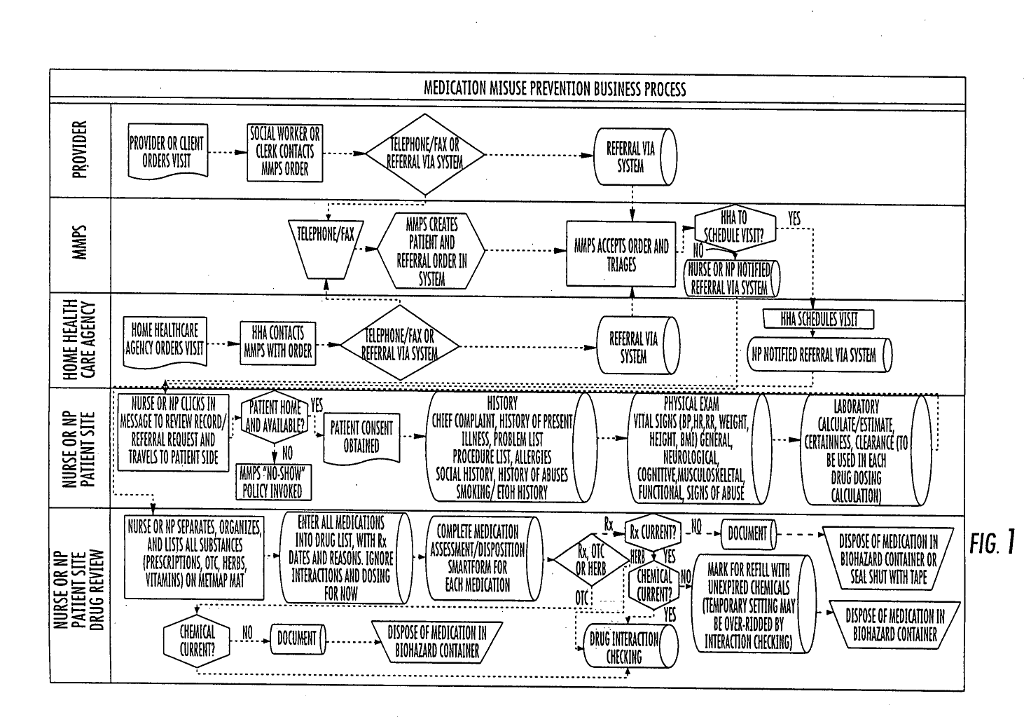

The individuals most likely to be “at risk” are usually the elderly and may also include individuals on disability, individuals on workman's compensation, patients with multiple pharmacological needs based upon a chronic or terminal diagnosis of any age. They may be living alone, but some have assistance or are living in a nursing home. The primary care giver for these individuals can order an evaluation of the individual by the services of the instant invention. Also, an evaluation can be ordered by a home healthcare agency, an HMO, an independent living facility, the patient, the patient's family, a fee for service or subscriber service or any other persons concerned with the welfare of an individual. This process is illustrated in the flowchart of FIG. 1. Once the care giver or requesting party decides to have an evaluation performed they can contact the Medication Misuse Prevention Service (MMPS) of the instant invention. A referral order is composed utilizing WEB technology that communicates with physicians and healthcare providers and MMPS accepts the order and starts the evaluation process. In addition to contacting MMPS by phone, an order can be placed electronically by authorized individuals. A referral order is then composed and MMPS accepts the order and starts the evaluation process.

Alternatively a Home Healthcare Agency (HHA) may become involved and conduct an evaluation of the individual through MMPS. A referral order is composed and MMPS accepts the order and starts the evaluation process. The Home Healthcare agency can also directly conduct an evaluation.

Next, a local Home Healthcare agency contacts the individual to schedule a visit. If successful, the agency will notify MMPS of the time and place of the evaluation. If a visit cannot be scheduled this is also entered into the MMPS system. A nurse or nurse practitioner (NP) checks the system for referral requests and indicates which individuals they will visit. In most cases a nurse will make the initial visit because it may not be necessary to make changes to medications for each individual. If the individual is at home their consent is obtained to preform a physical exam and obtain a history of their medical conditions and/or problems. If the individual is not at home this is indicated in the MMPS database as a “no show”. In this instance the nurse or nurse practitioner is still paid for the visit.

Once the individual's consent is given a history of the individual's medical conditions and/or problems is obtained. This history includes their major problem or complaint; a history of the current illness, if any; a list of problems such as Atrial fibrillation, congestive heart failure, and coronary artery disease; a list of procedures; a list of allergies, if any; and their social history which includes their current living conditions, use of tobacco or alcohol, etc. Next a physical examination is performed to obtain their vital signs. A determination is made of their general, neurological, cognitive, musculoskeletal, and functional conditions as well as any signs of abuse. If necessary laboratory tests may be ordered to determine if the medical conditions for which the individual is taken their current medications are still present.

The nurse or nurse practitioner organizes all the data and enters it into the MMPS database, which is HIPPA (Health Insurance Portability Accountability Act of 1996) compliant, at the patient's home electronically or manually when they return to their office if there is no wireless connection available. The data can be entered at the individual's residence if a wireless connection is available.

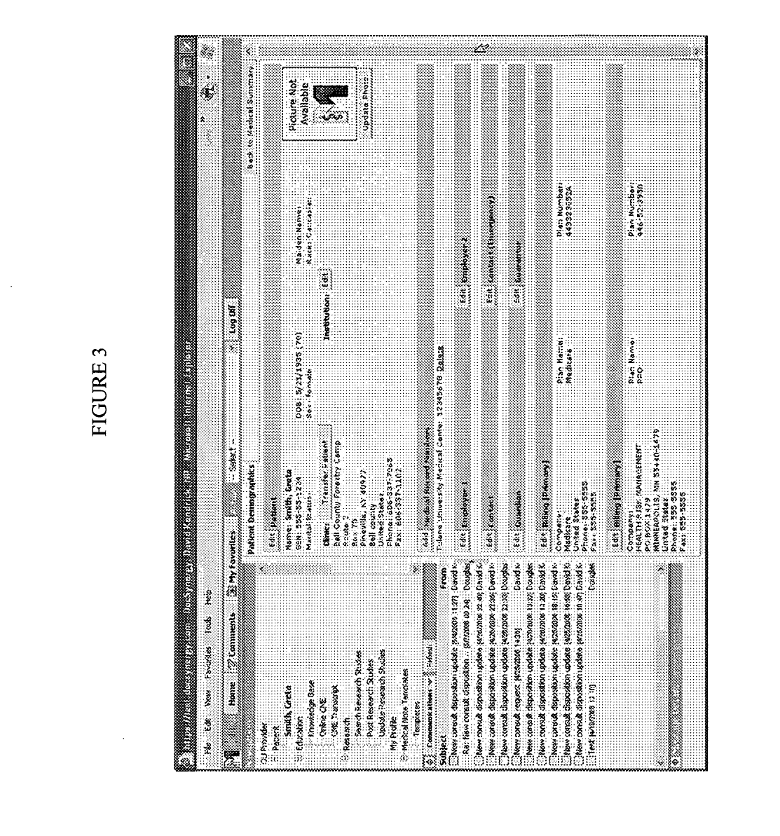

An example of the process for entering the data into the database is illustrated in the following screen shots. The user will first log onto the MMPS website and proceed to the MMPS software feature wherein a series of popup screens enable the user to quickly and correctly enter all the data for a particular individual. When the user selects a “new patient” a screen appears and an individual's demographics i.e. name, address, date of birth, SSN, healthcare provider, etc. can be entered. Next a screen appears identifying the patient and containing a plurality of menus. The menus include Problems; Procedures; Medications; Allergy; Vital Signs; Lab Results; Orders; Clinical Reminders and Clinical Notes. If some of the patient's demographics need to be modified the “demographics” button under the patient identification can be selected and the screen illustrated in FIG. 3 appears. Any of the patient's demographic data can now be modified.

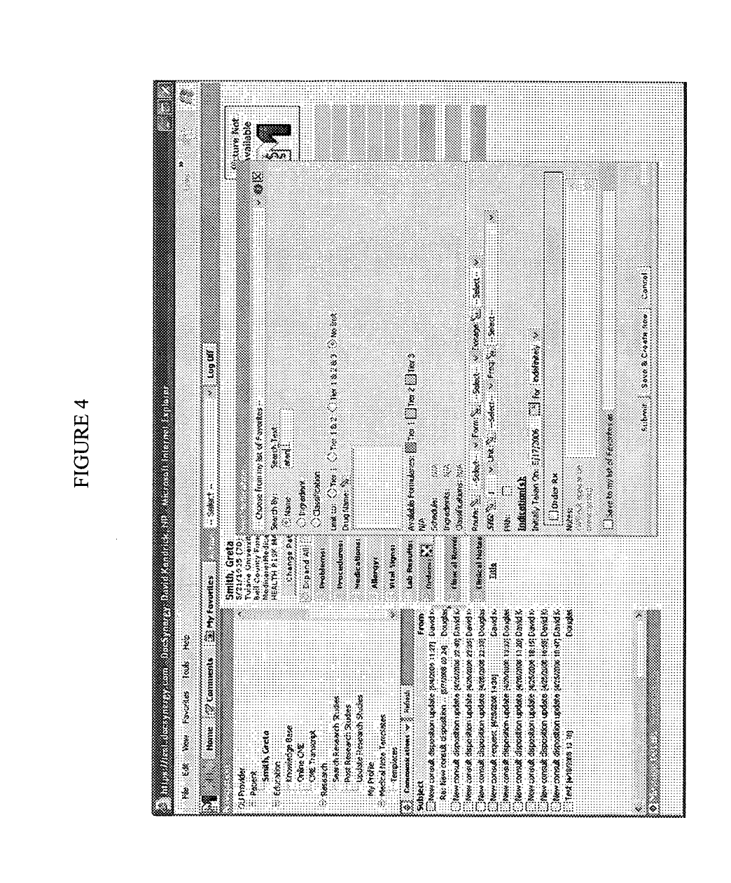

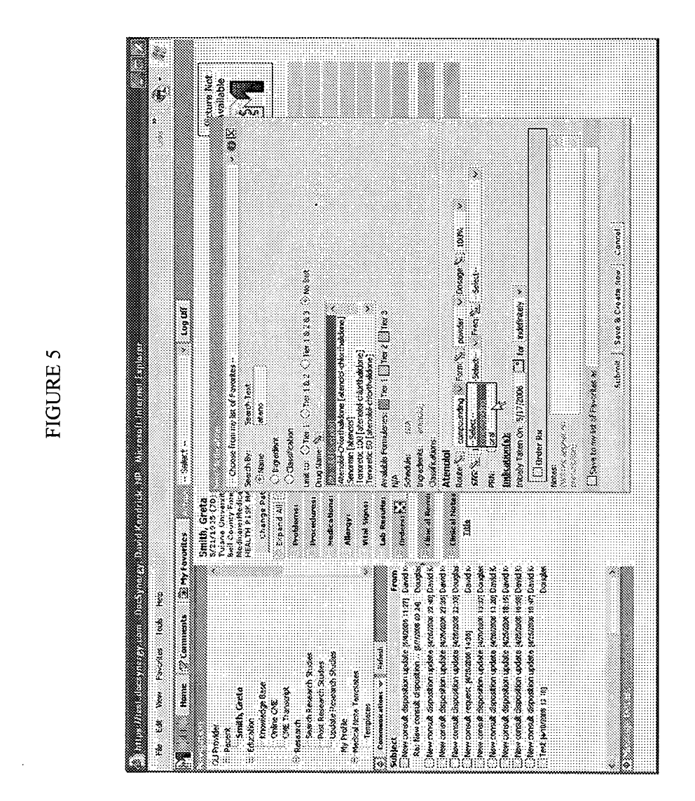

The nurse or nurse practitioner will now begin to enter the prescription medications, over the counter medications, vitamins, herbal medications and foods that interact with medications that the patient is currently taking or have been found in the home. This is done by selecting the “Medications:” menu and opening it. FIG. 4 illustrates the screen which appears and is used to enter medication information into the database. First the medication is searched by it's name and a pop-up list of similar medications appears, as illustrated in FIG. 5. The proper medication, in this case ATENOLOL, is selected from the list and the prescribed dosages are recorded.

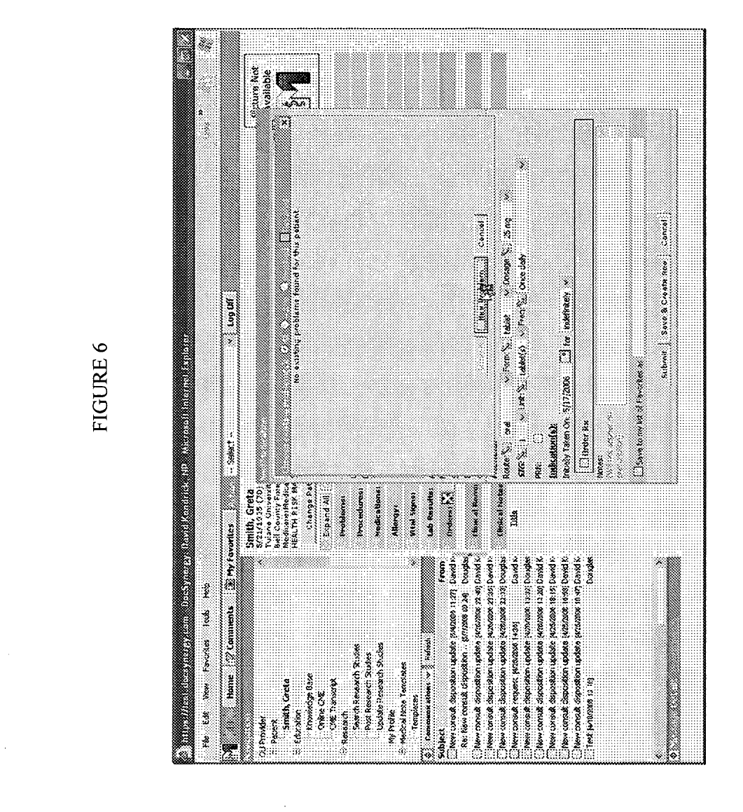

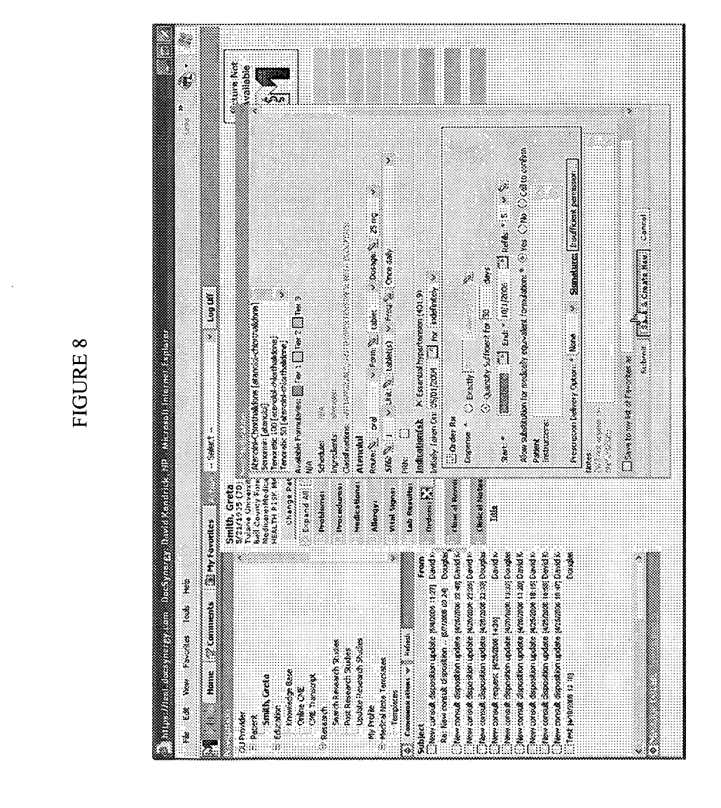

Next the “Indication(s):” link is selected and this brings up a “Problems” screen, shown in FIG. 6. The “New Problem” button can be selected and a list of medical problems associated with the previously prescribed medication is presented. The nurse or NP then selects which problem the current medication has been prescribed for. In the illustrated case it has been prescribed for Essential hypertension. Should the patient still have the condition then a screen, illustrated in FIG. 8, appears and a new prescription for the medication can be ordered. This data is saved so that a physician can retrieve it and sign the prescription.

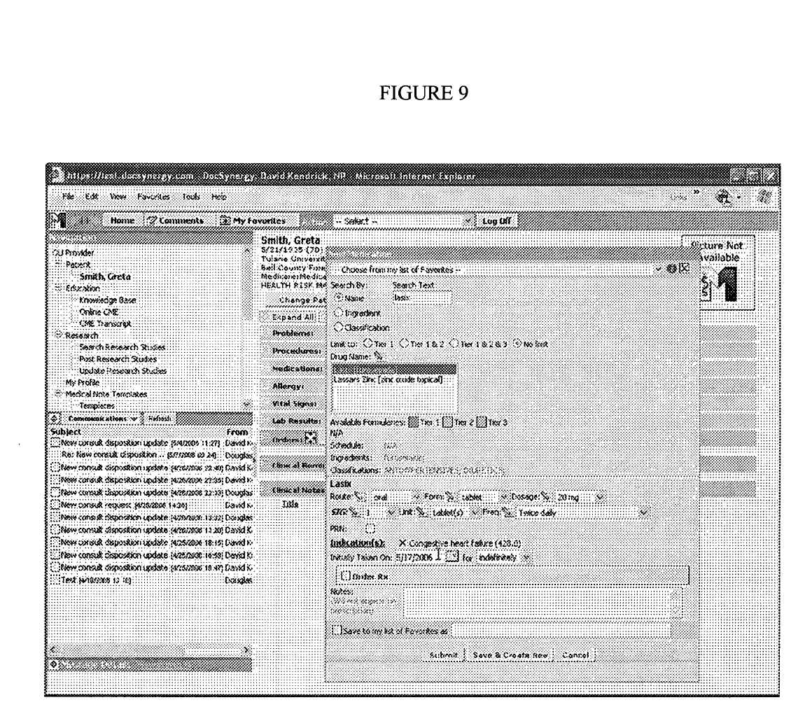

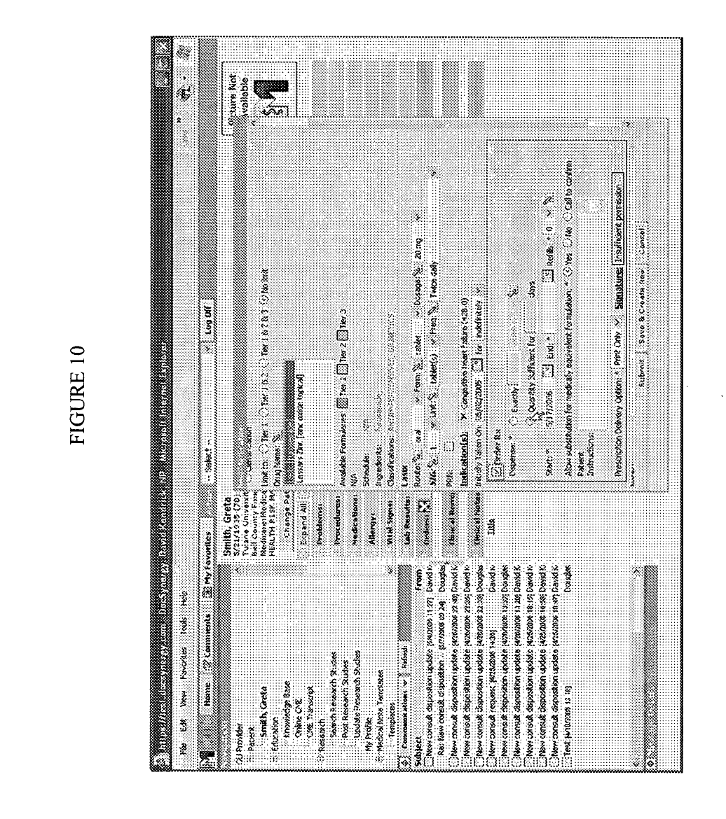

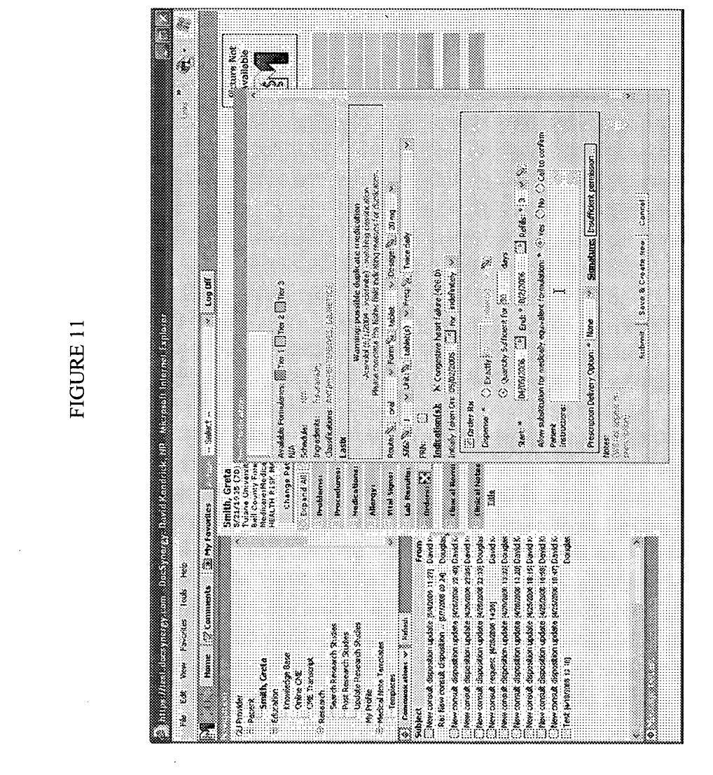

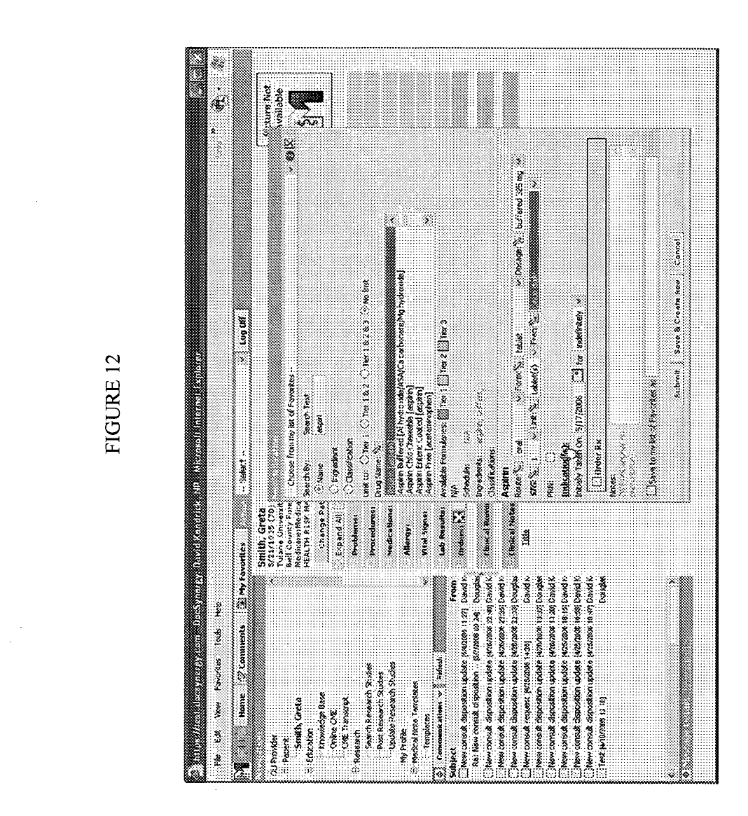

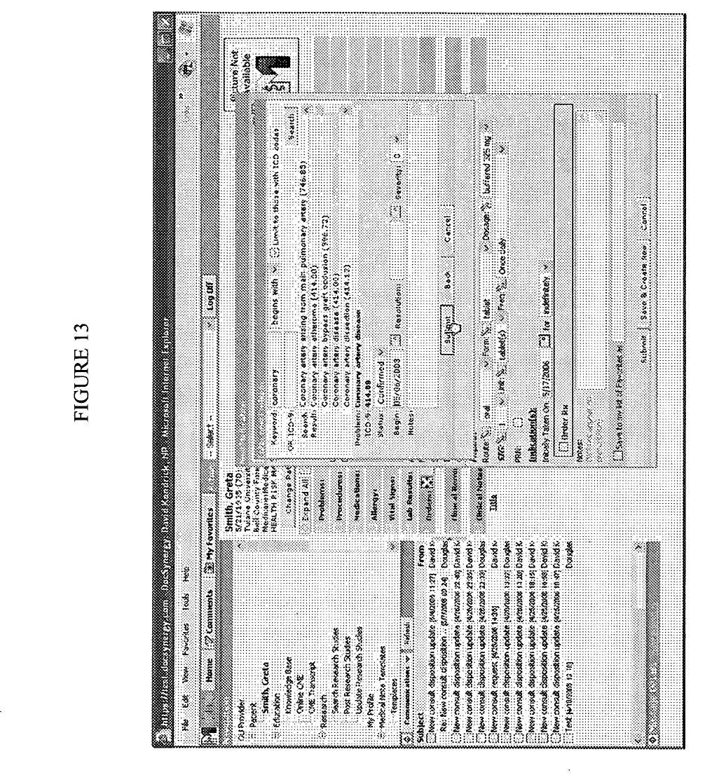

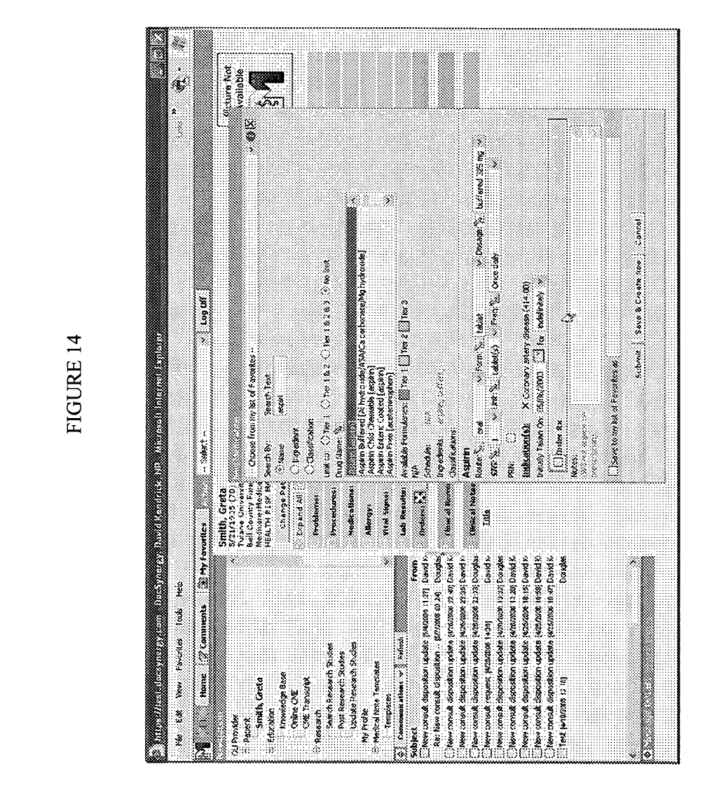

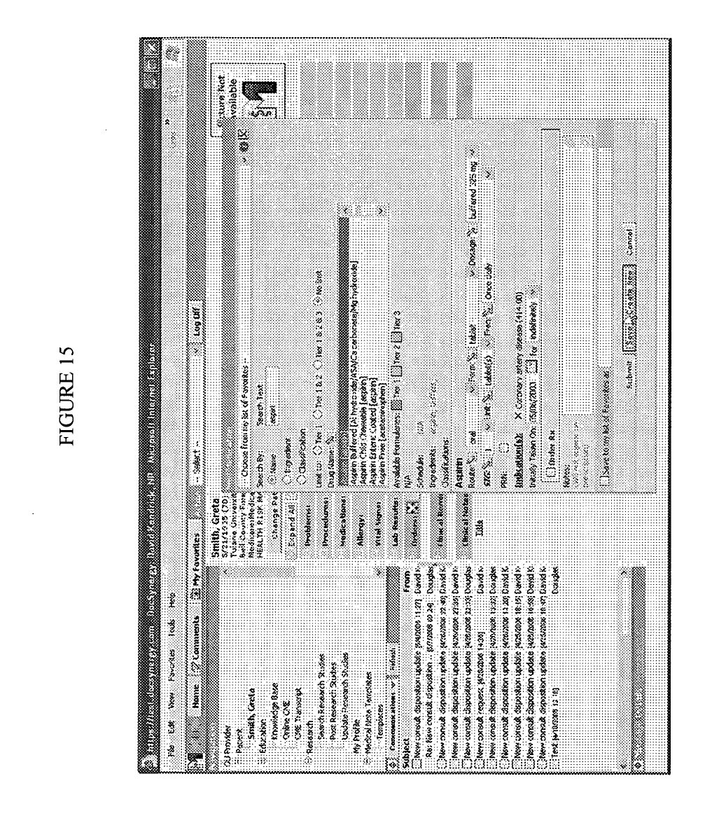

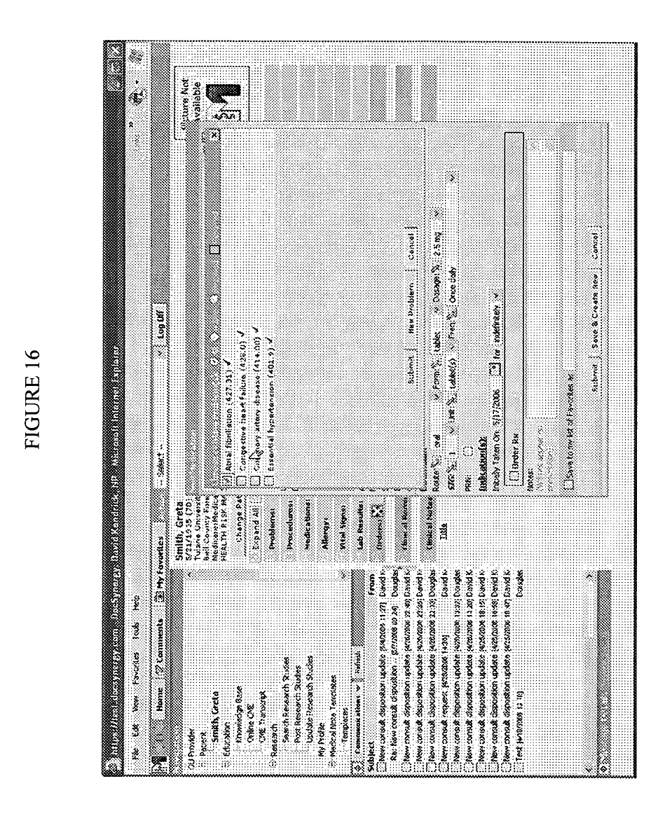

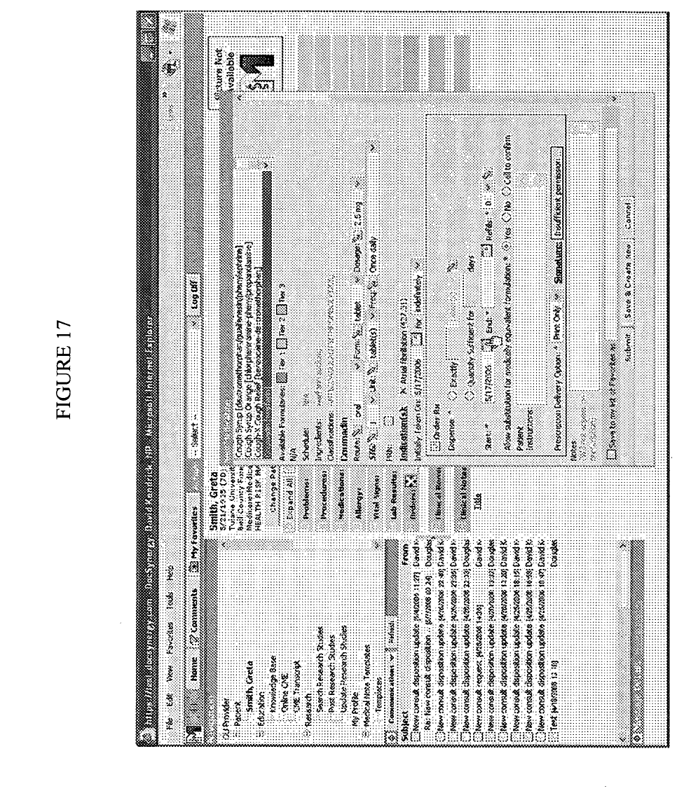

FIGS. 9-11 illustrate the screens wherein the information for the medication LASIX is entered. FIG. 11 illustrates the indication of a possible conflict of medications. In this case two of the medications appear to be duplicates. Should the person prescribing the medications want the patient to receive both medications they would make a note in the “Notes” box “OK in this instance” and the program would allow both medications to be prescribed. FIGS. 12-15 illustrate the screens for entering the information for aspirin and its associated problem Coronary artery disease. FIG. 16 illustrates the “problems” main screen which allows the user access to current or resolved problems. FIG. 17 illustrates the screen for ordering a prescription for COUMADIN.

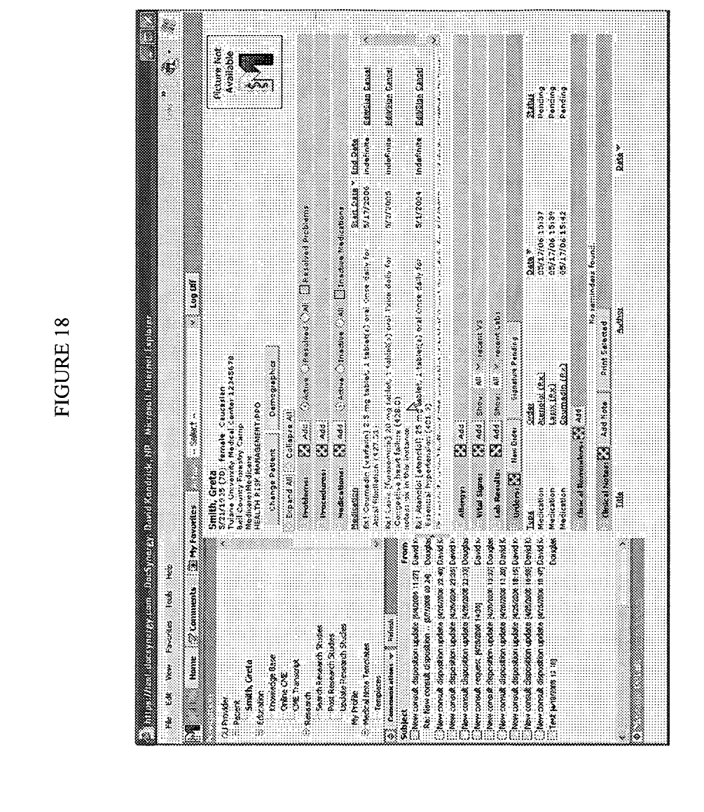

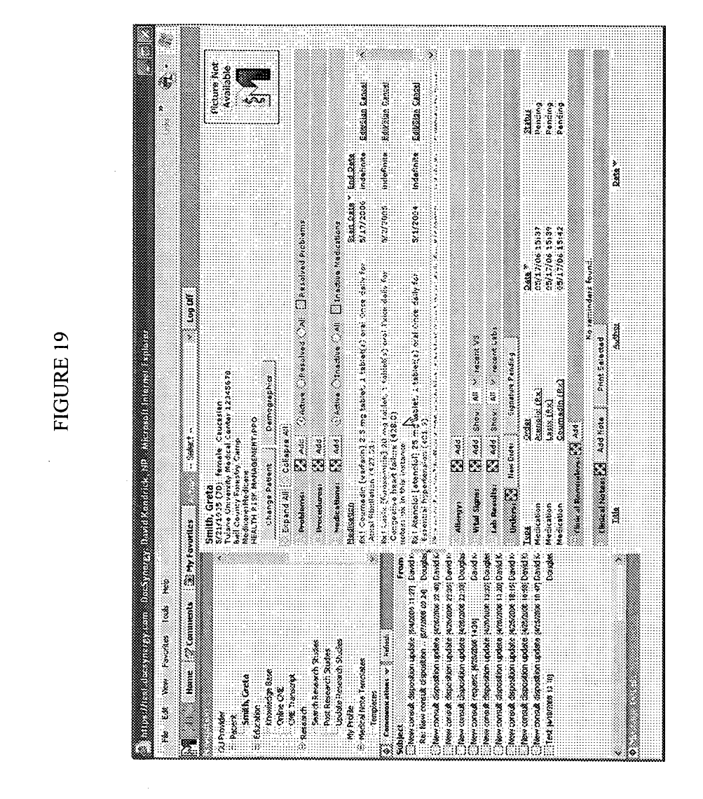

FIGS. 18 and 19 illustrate screens which allow the nurse or NP to check the medications that patient is currently taking and write a new or substitute prescription or refill prescription.

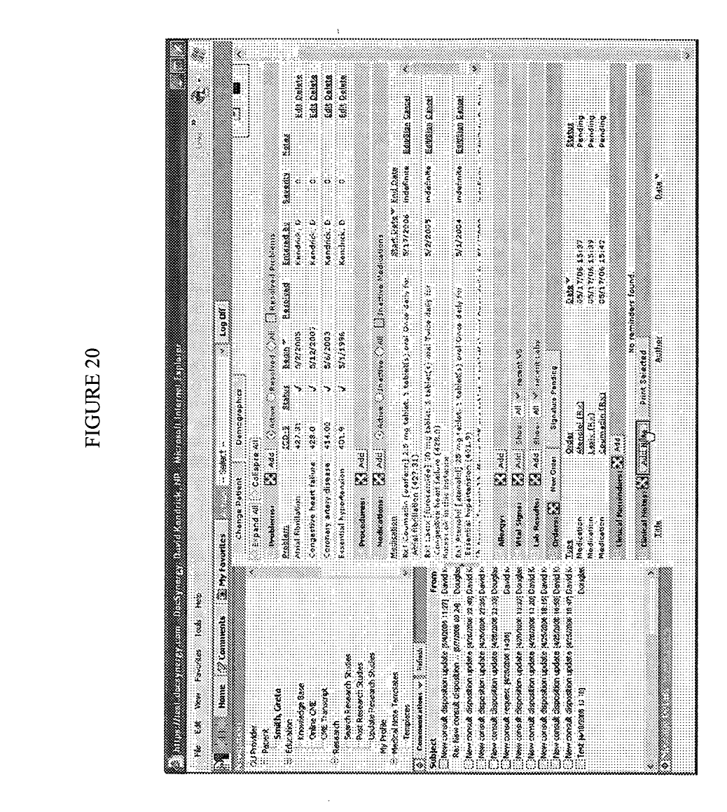

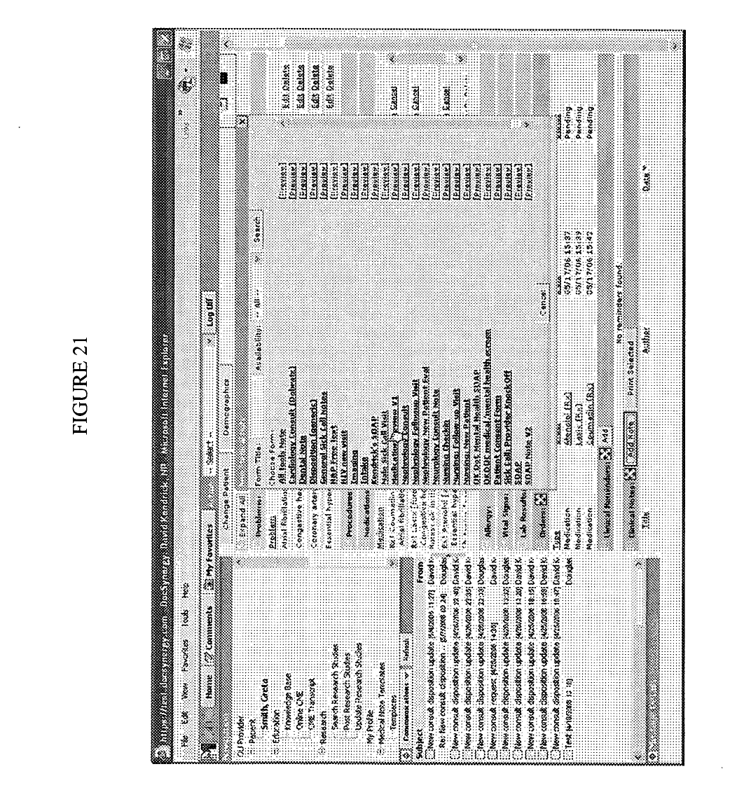

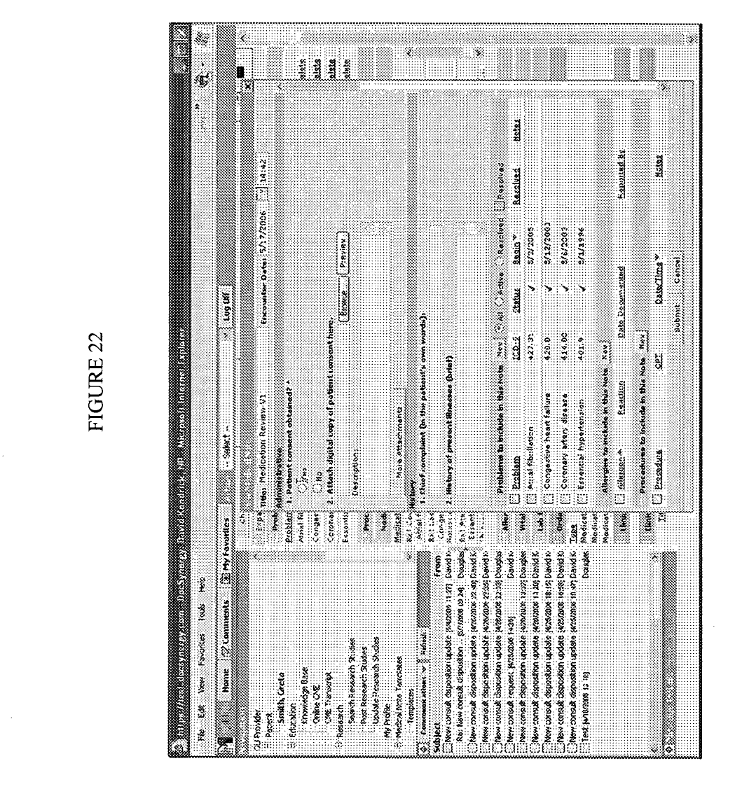

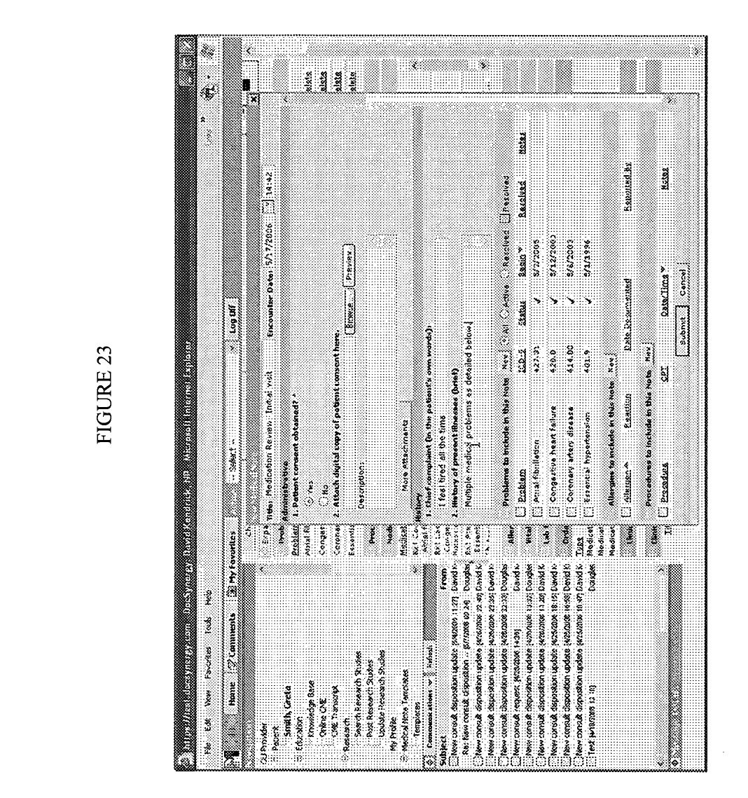

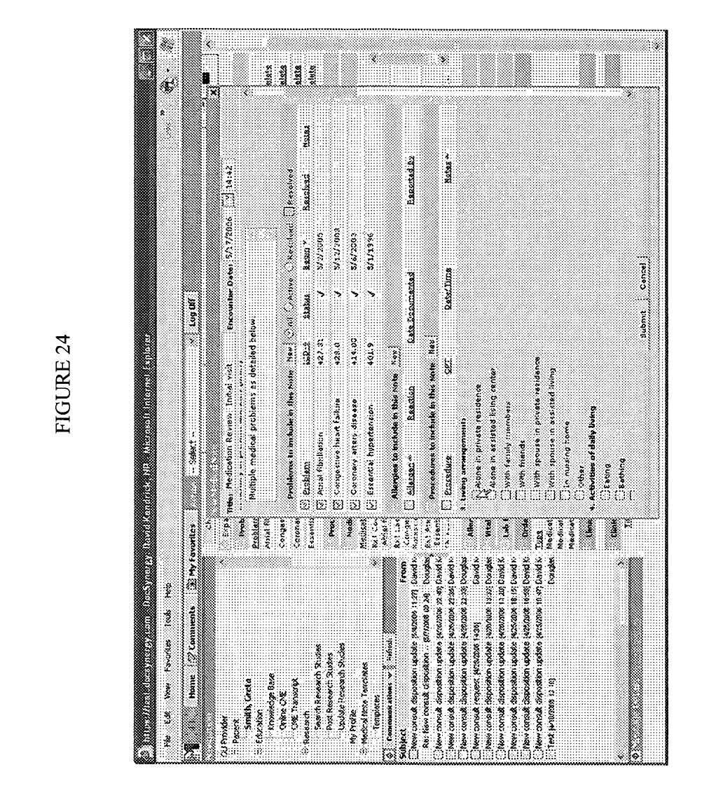

The nurse or NP will now go to the “Clinical Notes” menu to enter additional data as illustrated in FIG. 20. After the Add Note button is selected a New Medical Note screen appears, as shown in FIG. 21. The nurse or NP can select the Medication Review link which opens the screen shown in FIG. 22. Here is where a record of the patient's consent is entered and also their history. FIG. 23 illustrates an entry of the current chief complaint and history of the present illnesses. Next the living arrangements of the patient are entered into the database. For example in the illustrated example the patient is living alone in a private residence. As shown in FIG. 24 there is also an area, “Other” for additional comments.

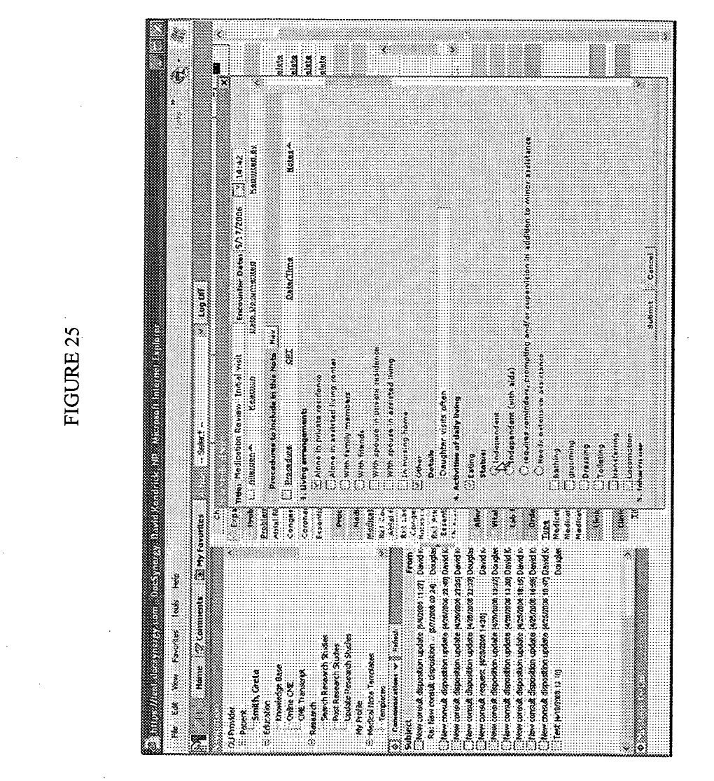

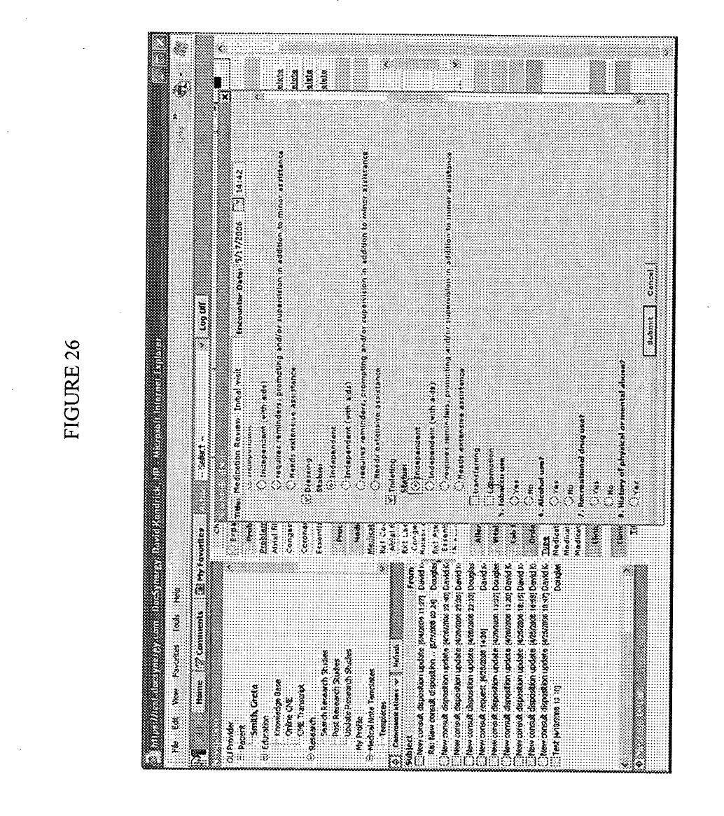

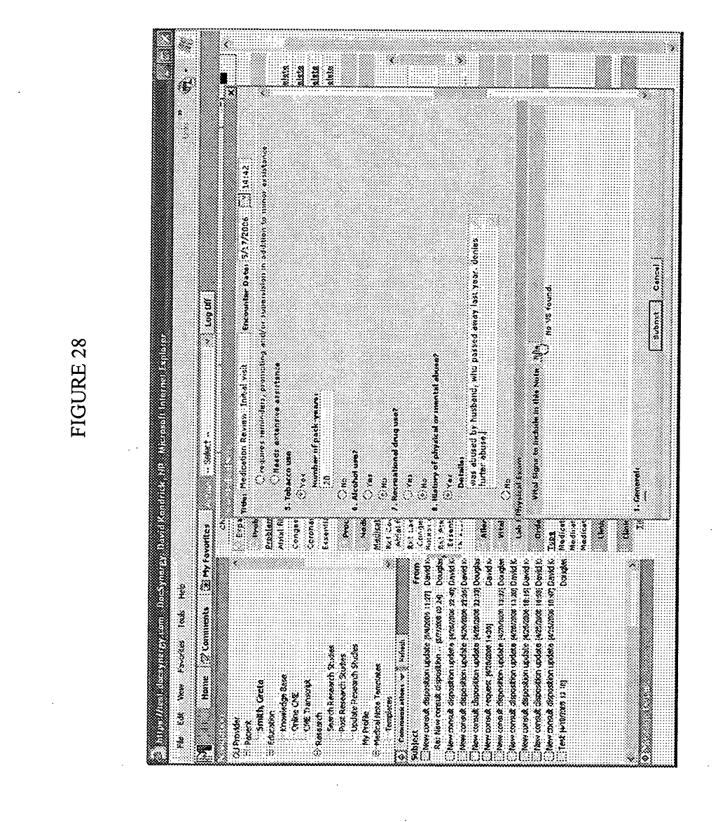

Next the activities of daily living are entered. These include eating, bathing, grooming, dressing, toileting, transferring, and locomotion. FIGS. 25 and 26 illustrate that once each of the daily living activities is selected an additional menu appears to allow the entry of the specifics of each activity. The next information entered relates to tobacco use, alcohol use, recreational drug use and history of physical or mental abuse. Each of these categories has a “yes” or “no” answer. If the “yes” answer is selected then an additional box appears to provide details of the yes answer. For example, as illustrated in FIG. 28 under “History of physical or mental abuse” when the “yes” answer was selected a box appeared so that the person conducting the interview could further refine the answer. In the illustrated example the patient was abused by her husband, however, he passed away and she denies that there is any further abuse.

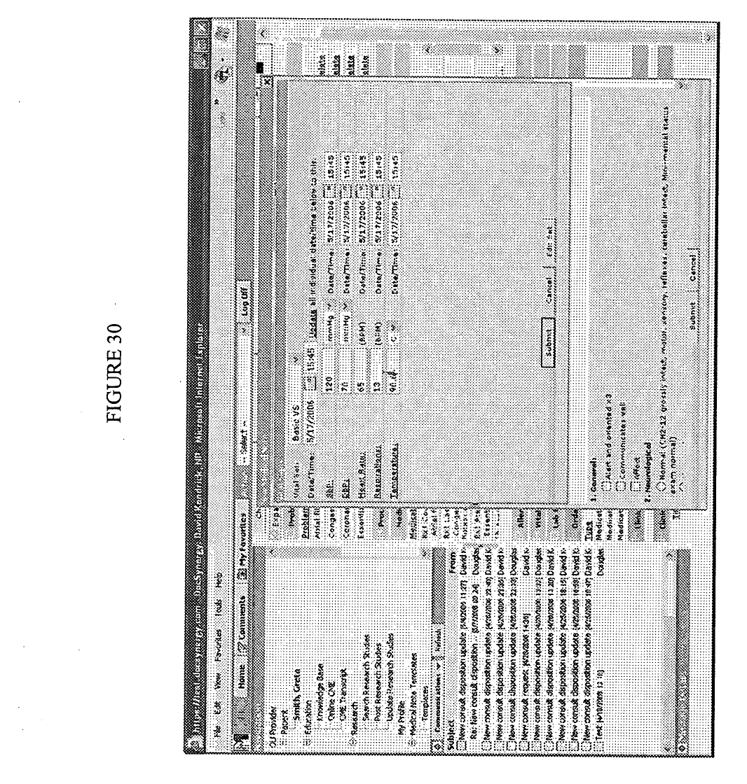

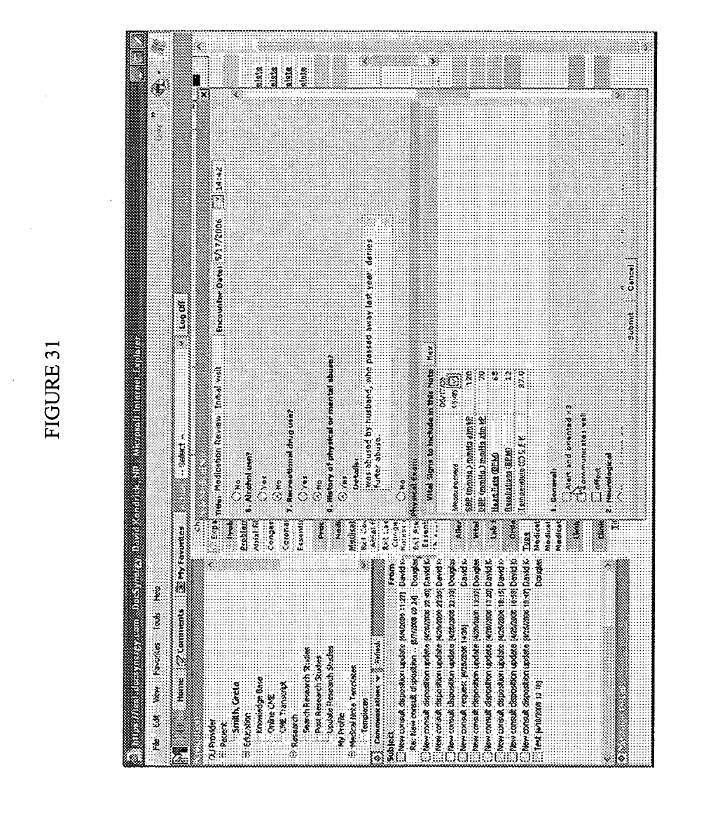

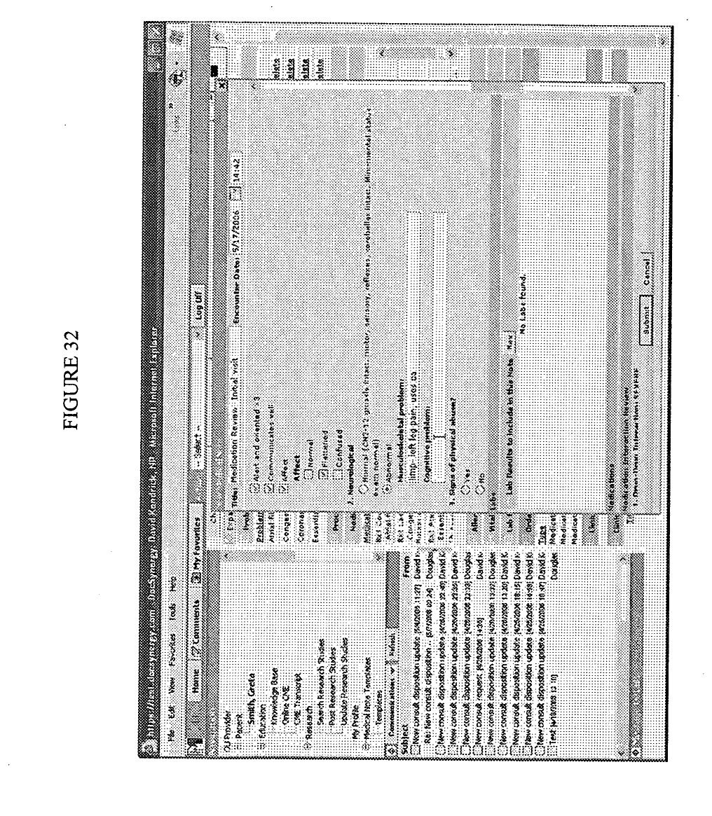

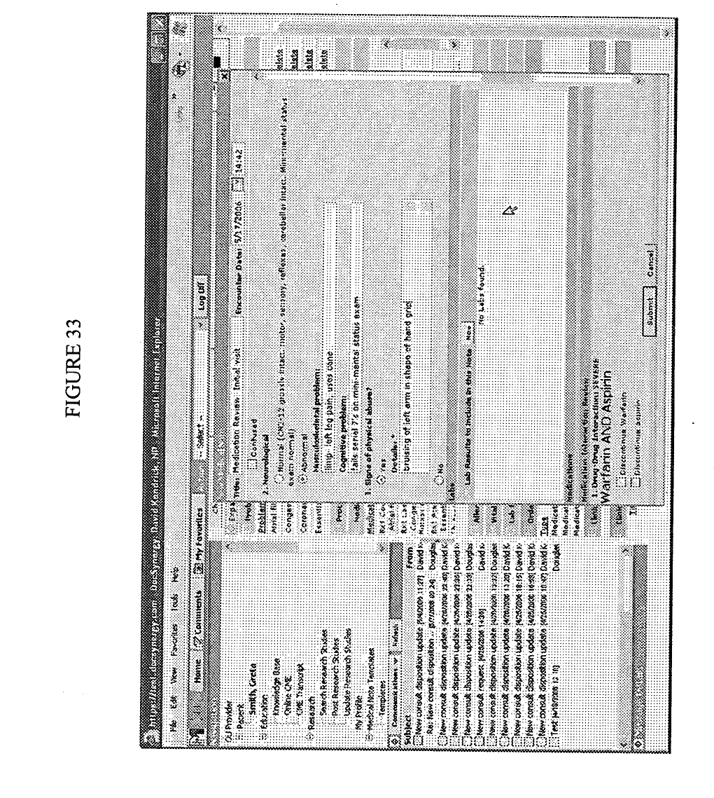

Once this information has been entered the nurse or NP will measure the vital signs of the patient and enter this into the database. The “Vital signs” menu is opened and a screen appears with areas to enter the patient's blood pressure, heart rate, respiration, and body temperature. Also the date and time at which these measurements were taken. This is illustrated in FIG. 30. After this data has been entered into the database it will appear in the medical review as illustrated in FIG. 31. The nurse or NP then continues with the medical review by defining the general condition of the patient. Are they alert? Do they communicate well? Next the neurological condition of the patient is evaluated. As illustrated in FIGS. 32 and 33 if there are neurological problems then the “abnormal” button is selected and additional categories with information boxes appear so that the person conducting the examination can provide specifics with respect to these areas. Next the nurse or NP indicates if there are any signs of physical abuse. In the illustrated example there was a bruise of the left arm,of the patient in the shape of a hand grip.

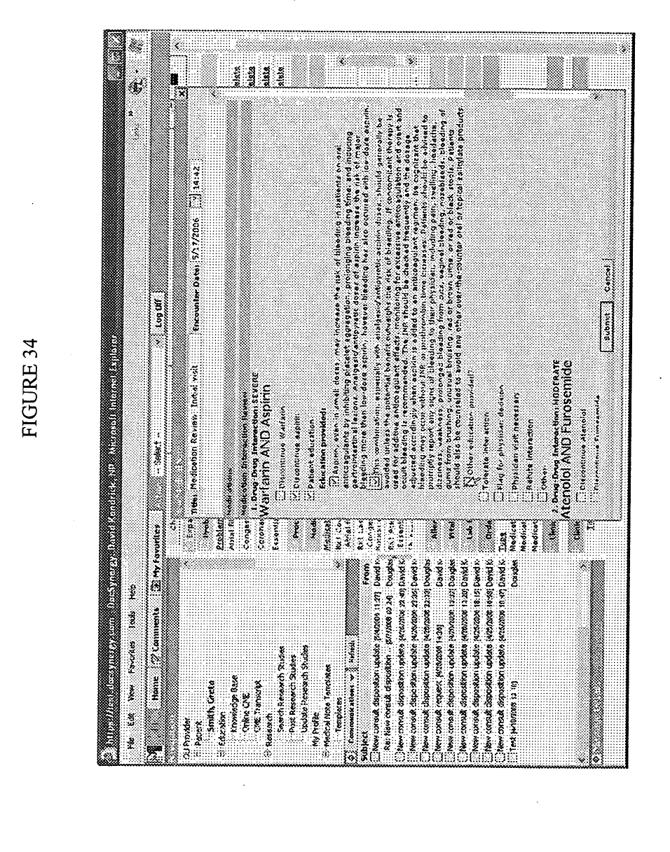

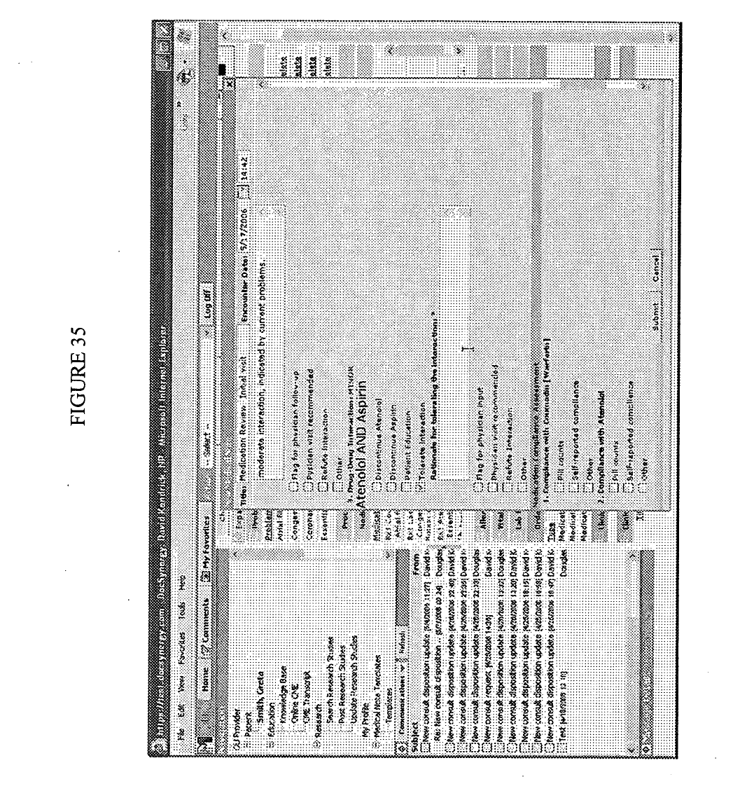

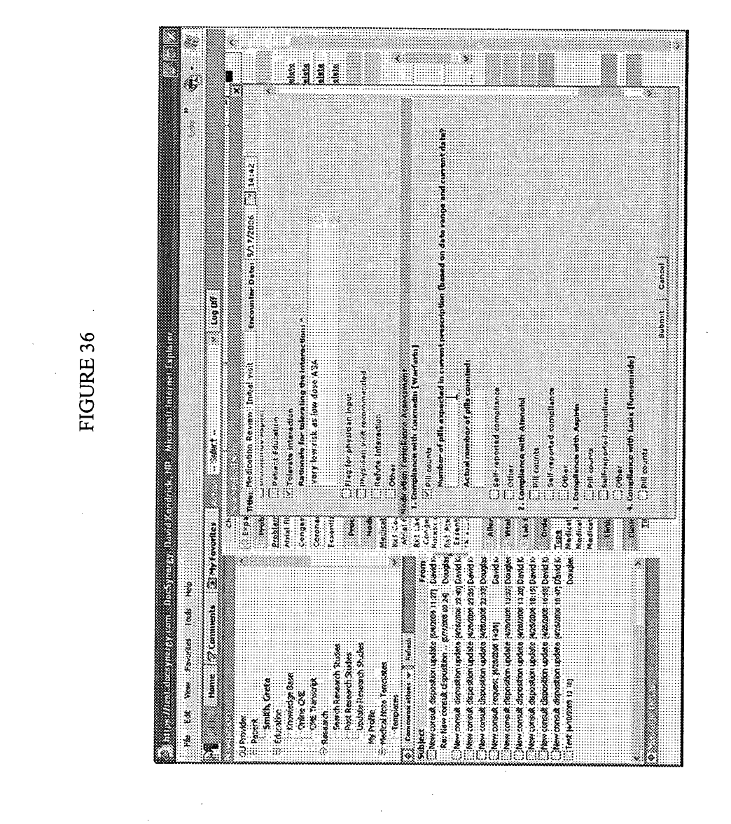

The next area is for laboratory results from laboratory tests ordered by a physician or other individual. In the illustrated example there are no laboratory results to report. Following this the “Medication Interaction Review” information is provided. In this area the interactions of drugs that the patient is taking are indicated. The nurse or NP can then enter their recommendations with respect to each drug interaction. In the first example, illustrated in FIG. 34, there is a severe interaction between WARFAIN and aspirin. The recommendation is to discontinue the aspirin and educate the patient with respect to the dangers of this interaction. In FIG. 35 under the interaction of ATENOLOL and FUROSEMIDE the “Tolerate interaction” box is selected and a note is made that the nurse is aware of the interaction. FIG. 36 illustrates the interaction between ATENOLOL and aspirin. The interaction is to be tolerated as a result of the very low risk because of a low dose of aspirin.

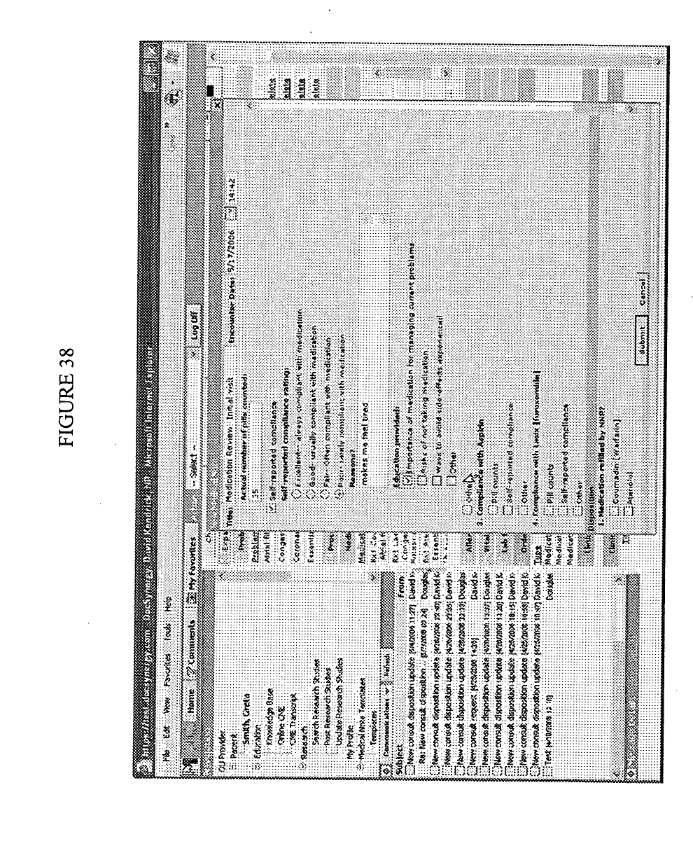

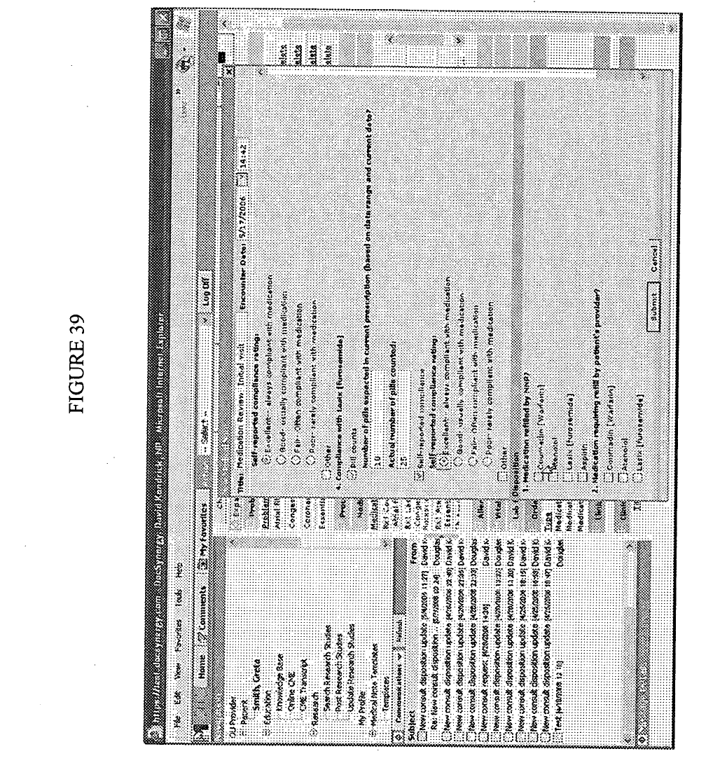

The Medical Compliance Assessment portion of the medical notes is completed next. The nurse or NP counts the pills in each pharmaceutical prescription and compares them with the number of pills that should be present based on the dosage and date on which the prescription was filled. If the pill counts are close to each other then the self-reported compliance rating is excellent and no further action is required. If the compliance is poor as illustrated with the medication ATENOLOL then a box appears so that an explanation of the poor compliance can be indicated. In the example illustrated in FIG. 38, the reason for poor compliance is that the medication makes the patient feel tired. Following this are choices of education which should be provided to the patient to increase their compliance. In the example illustrated the importance of taking this medication for managing the patient's current problems has been selected.

While the nurse or NP is checking for the patient's compliance with their medications they can check to see if the prescriptions are current and if the medications themselves are current. If the prescriptions are not current and the medications are no longer required then the nurse or NP will document this and properly dispose of the medications as illustrated in FIG. 1. If the prescriptions are current but the medications are out of date then the nurse or NP will properly dispose of the medications and order a new prescription.

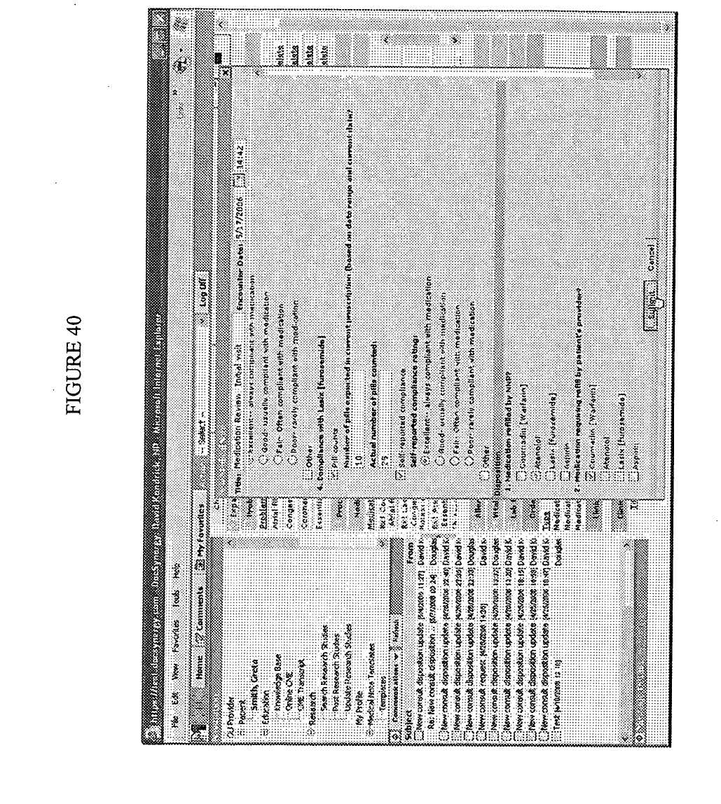

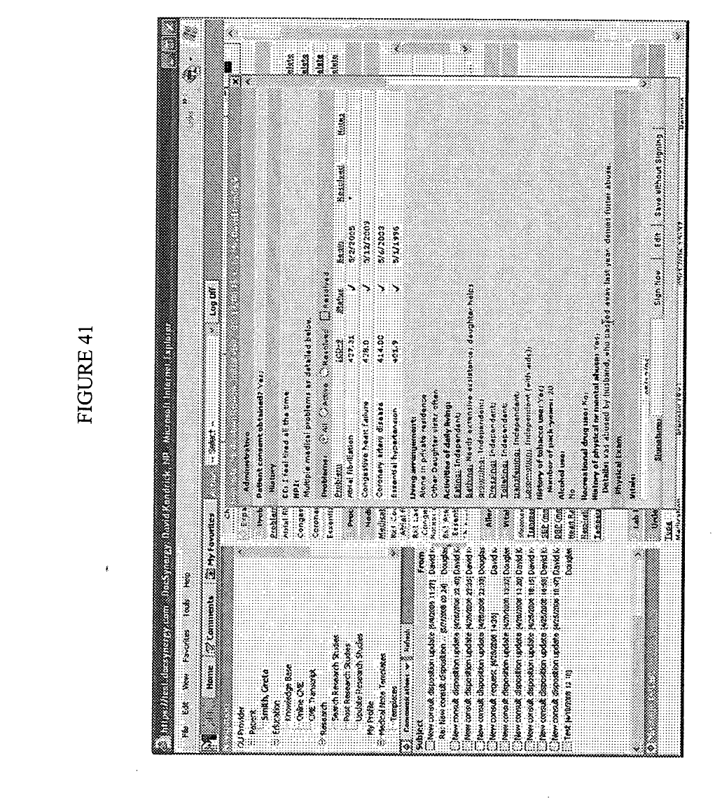

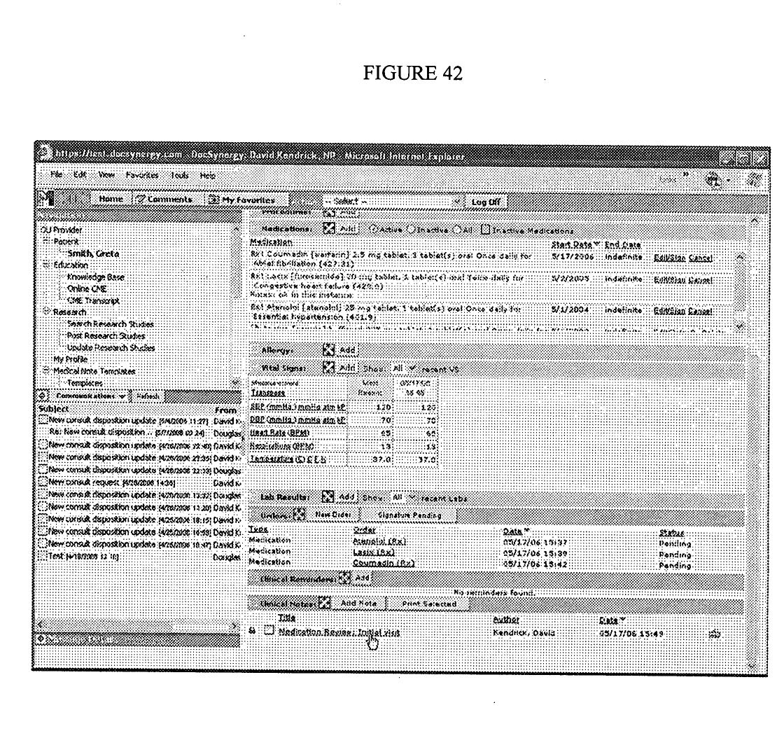

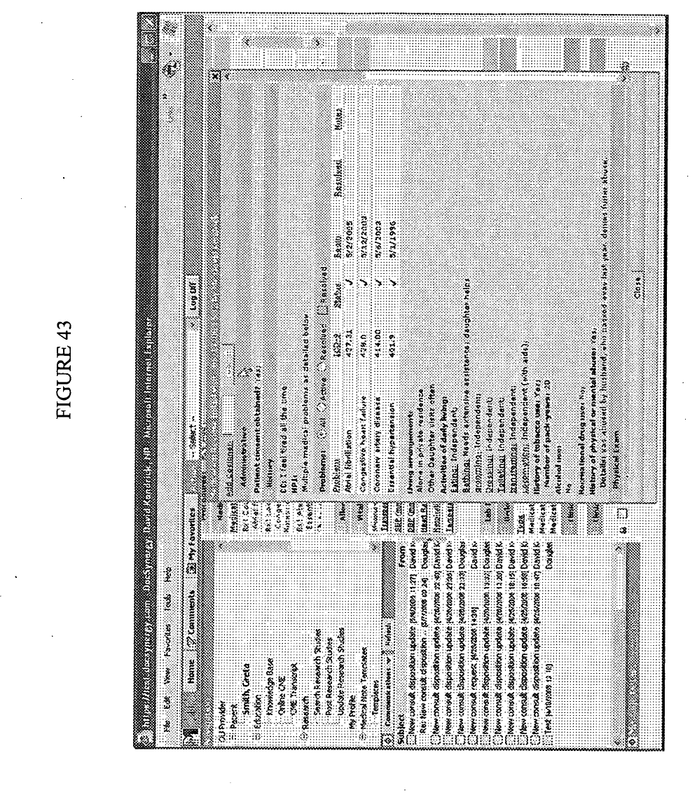

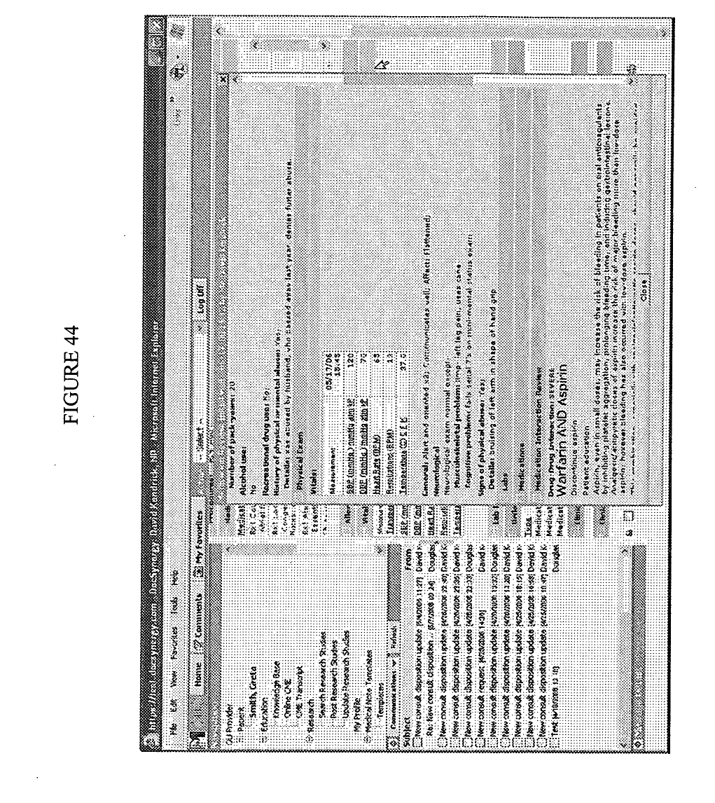

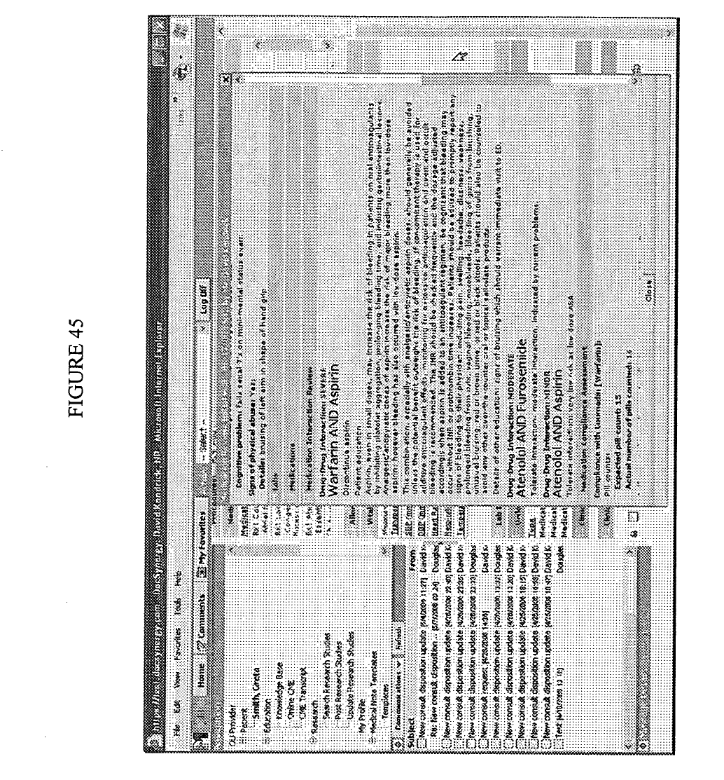

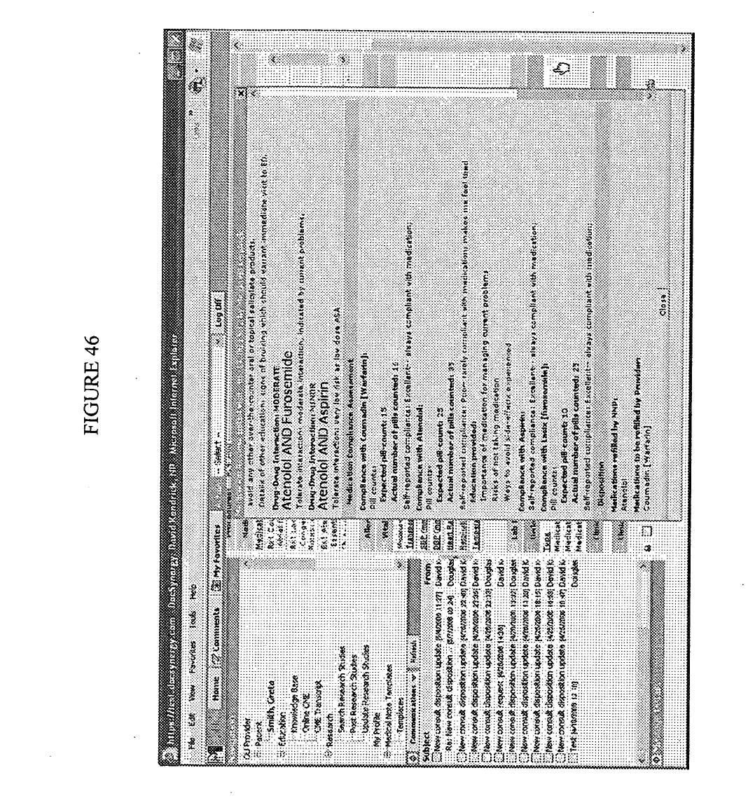

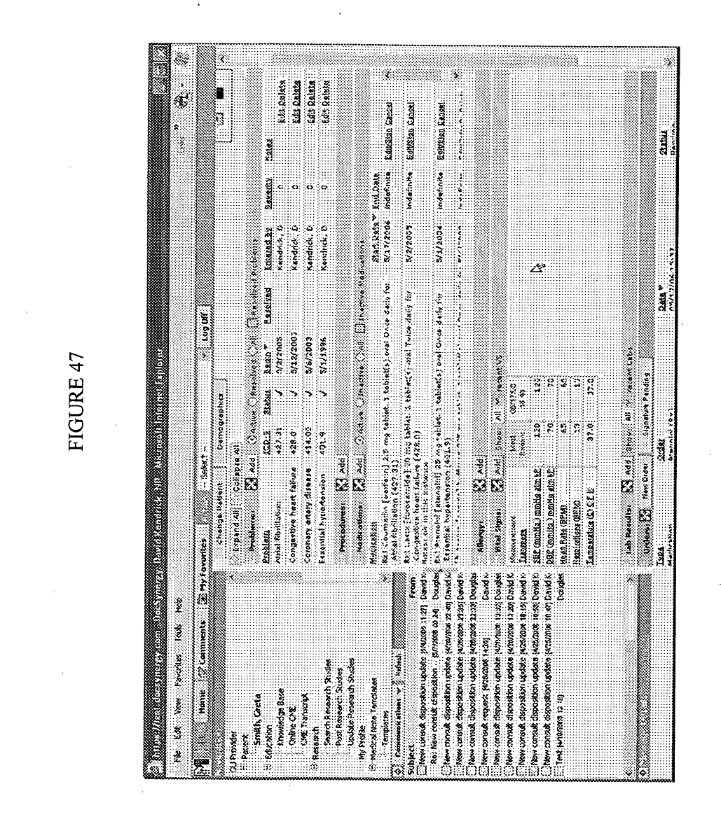

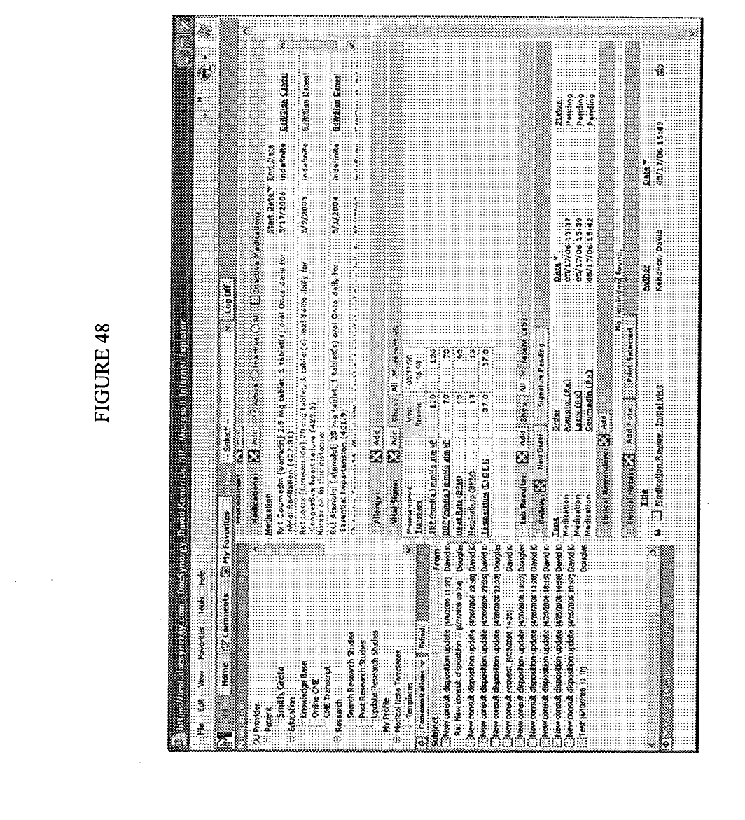

The “Disposition” portion of the medical notes is completed next. In FIG. 40 the current prescribed medications which are to be provided by the nurse or NP and the medications to be provided by the patient's provider are indicated. After this information has been entered the “Submit” button at the bottom of the screen is selected and another screen, FIG. 41, appears with a summary of all the information entered by the nurse or NP. There is an area at the bottom of the screen for the nurse or NP to digitally sign. Thus indicating that they have provided the information and checked its accuracy. This information can also be checked and verified by another person. The other person need not be present and can access the information by logging onto the website and checking the information entered. In the illustrated example, FIG. 42, Dr. Bob Smith selects the “Medication Review: Initial visit” under the Clinical Notes. He then enters his name as a cosigner, FIG. 43. He reviews all the information, FIGS. 44-48 and if satisfied closed the screen and logs off the website.

If required a psychological evaluation or screening, employing standardized tests, will be performed. This is designed to evaluate or rule out the potential for addictive behaviors, general level of functioning and abuse of existing prescriptions or illegal drugs. If the initial scores indicate that there are significant risk factors, then a thorough psychiatric/mental health evaluation will be requested and scheduled.

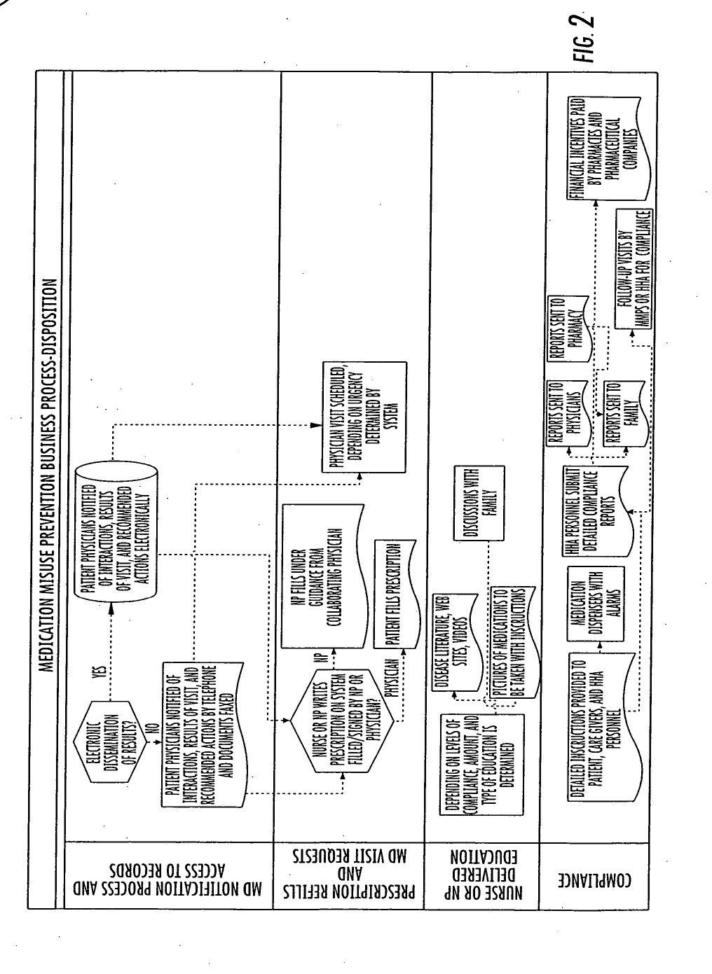

As illustrated in FIG. 2, once the patient has been evaluated all of the physicians that have seen the patient are notified and they can log onto the website to view the results or can have the results faxed to them. If new prescriptions for medications are required the physician can approve or override the prescription renewal or prescription change written by the nurse or NP. If a determination has been made by the person interviewing the patient that a visit to a physician is necessary then the physician will be asked to now schedule the visit. In addition, other authorized individuals concerned with the patient's well being may access the database with proper authorization. These include nurses, nurse practitioners, patient guardians, members of the patient's family, home healthcare agencies, social welfare agencies, health insurance companies, HMOs, subscribers to services which utilizes the data in the database and other third parties with proper consent.

Depending on the levels of compliance of the patient with their medication, certain education by the nurse or NP may be required. At this point the patient will be provided with educational materials, videos or web sites to help educate them as to the importance of their medications to their health and the proper dosages of the medications. A discussion with the members of the patient's family will usually shed some light as to the reasons for the lack of compliance with certain medications. Pictures and specific instructions regarding these medications may be required.

To assure compliance with the prescribed medications detailed instructions are provided to the patient, their care givers, and the Home Healthcare Agency associated with the patient regarding the proper use and dosages of the prescription medications. One of the methods of compliance utilizes medication dispensers with alarms or other features so that a patient will be reminded when to take their medication. The patient's progress can be monitored by the Home Healthcare Agency which will prepare detailed reports regarding the patient's compliance with their medications and send these reports to the patient's physician, family and pharmacy. There can also be followup visits by the MMPS to check for patient compliance with their medications.

In certain instances there can also be financial incentives provided by pharmaceutical companies, HMOs and/or pharmacies to encourage patient compliance with their medications.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A computer assisted method for assessing possible misuse of consumables comprising:
assembling a consumable database for an individual, said consumable database including prescribed and non-prescribed medications, vitamins, herbs, dietary supplements, and recently ingested foods;
comparing said consumable database to an interaction database for creating a compliance report;
interpreting said compliance report to determine if immediate intervention is required due to a non-compliance condition;
measuring both physical and psychological functions of an individual that is in a compliance condition, said functions characterized in a function report; and
summarizing said compliance report and said function report, whereby said summary is available for interpretation by qualified personnel to access possible misuse of consumables.

2. A computer assisted method for assessing the possible misuse of consumables comprising:
providing an assessment of a patient's medication regimen including determining medications, over the counter medications, vitamins, herbals or foods which interact with medications said patient is currently taking, determining if there are any inappropriate medications said patient is taking;
determining said patient's compliance with their medication regimen including confirmation-of their medication needs, confirmation that said patient is taking the medications according to instructions;
providing intervention if necessary to assure that said patient is complying with their medication regimen, monitoring both physical and psychological functions to detect early signs of adverse medication interactions or toxicity;
providing education to said patient and their care givers regarding the appropriate use of medications; and
providing data analysis of the information obtained regarding each said patient.

3. The computer assisted method of claim 2, further comprising ordering an assessment of said patient's medication regimen by a physician, nurse practitioner, care giver, home healthcare agency or others concerned with said patient's welfare.

4. The computer assisted method of claim 2 further comprising performing a physical examination of said patient to determine said patient's medical condition.

5. The computer assisted method of claim 2 further comprising entering said assessment of said patient's medication regimen into a database.

6. The computer assisted method of claim 2 wherein said database is compliant with Health Insurance Portability ccountability (HIPPA) regulations and access is restricted to individuals associated with said patient's well being or third parties with consent of the patient or the patient's guardians.

7. The computer assisted method of claim 2 wherein said assessment of said patient's medication regimen includes prescription medications, over the counter medications and herbal medications.

8. The computer assisted method of claim 2 wherein determining said patient's compliance with their medication regimen includes counting the pills remaining in a given medication prescription and comparing the results to the number of pills that should be remaining in said prescription if said patient has been complying with their medication regimen.

9. The computer method of claim 2 wherein determining said patient's compliance with their medication regimen includes asking the patient if they are complying with their medication regimen.

10. The computer assisted method of claim 2 wherein said assessment of said patient's medication regimen includes determining if there are any adverse interactions between the medications which said patient is taking.

11. The computer assisted method of claim 10 further determining if any of said adverse interactions can be tolerated by said patient.

12. The computer assisted method of claim 10 wherein after determining that an adverse interaction between medications is present, determining if there are alternate medications which can be substituted for the adverse interaction medication.

13. The computer assisted method of claim 2 further comprising conducting laboratory tests to determine if said patient still has the medical conditions which necessitated certain medication prescriptions.

14. The computer assisted method of claim 12 wherein said determination of said patient's compliance with their medication regimen includes writing a new prescription or refilling an existing prescription for a medication in said patient's medication regimen.

15. The computer assisted method of claim 2 further comprising determining said patient's daily living activities.

16. The computer assisted method of claim 15 wherein a notation is made in a database when a determination is made that an adverse condition is present in said patient's daily living activities.

17. The computer assisted method of claim 16 wherein an authorized individual can access said database, evaluate said adverse condition, and recommend a course of action to remove or correct said adverse condition.

18. The computer assisted method of claim 2 further including a psychological evaluation of said patient.

19. An interactive computer system containing a database and executing a method for assessing the possible misuse of consumables comprising:
providing an assessment of a patient's medication regimen including determining medications, over the counter medications, vitamins, herbals or foods which interact with medications said patient is currently taking, determining if there are any inappropriate medications said patient is taking;
determining said patient's compliance with their medication regimen including confirmation of their medication needs, confirmation that said patient is taking the medications according to instructions;
providing intervention if necessary to assure that said patient is complying with their medication regimen, monitoring both physical and psychological functions to detect early signs of adverse medication interactions or toxicity;
providing education to said patient and their care givers regarding the appropriate use of medications; and
providing data analysis of the information obtained regarding each said patient.

20. The interactive computer system of claim 19, further comprising ordering an assessment of said patient's medication regimen by a physician, nurse practitioner, care giver, home healthcare agency or others concerned with said patient's welfare.

21. The interactive computer system of claim 19 further comprising performing a physical examination of said patient to determine said patient's medical condition.

22. The interactive computer system of claim 19 further comprising entering said assessment of said patient's medication regimen into a database.

23. The interactive computer system of claim 19 wherein said database is compliant with HIPPA regulations and access is restricted to individuals associated with said patient's well being or third parties with consent of the patient or the patient's guardians.

24. The interactive computer system of claim 19 wherein said assessment of said patient's medication regimen includes prescription medications, over the counter medications and herbal medications.

25. The interactive computer system of claim 19 wherein determining said patient's compliance with their medication regimen includes counting the pills remaining in a given medication prescription and comparing the results to the number of pills that should be remaining in said prescription if said patient has been complying with their medication regimen.

26. The interactive computer system of claim 19 wherein determining said patient's compliance with their medication regimen includes asking the patient if they are complying with their medication regimen.

27. The interactive computer system of claim 19 wherein said assessment of said patient's medication regimen includes determining if there are any adverse interactions between the medications which said patient is taking.

28. The interactive computer system of claim 27 further determining if any of said adverse interactions can be tolerated by said patient.

29. The interactive computer system of claim 27 wherein after determining that an adverse interaction between medications is present, determining if there are alternate medications which can be substituted for the adverse interaction medication.

30. The interactive computer system of claim 19 further comprising conducting laboratory tests to determine if said patient still has the medical conditions which necessitated certain medication prescriptions.

31. The interactive computer system of claim 19 wherein said determination of said patient's compliance with their medication regimen includes writing a new prescription or refilling an existing prescription for a medication in said patient's medication regimen.

32. The interactive computer system of claim 19 further comprising determining said patient's daily living activities.

33. The interactive computer system of claim 32 wherein a notation is made in a database when a determination is made that an adverse condition is present in said patient's daily living activities.

34. The interactive computer system of claim 33 wherein an authorized individual can access said database, evaluate said adverse condition, and recommend a course of action to remove or correct said adverse condition.

35. The interactive computer system of claim 19 further including a psychological evaluation of said patient.

36. A computer-readable medium storing computer executable process steps for accessing the possible misuse of consumables, the process steps comprising:
providing an assessment of a patient's medication regimen including determining medications, over the counter medications, vitamins, herbals or foods which interact with medications said patient is currently taking, determining if there are any inappropriate medications said patient is taking;
determining said patient's compliance with their medication regimen including confirmation of their medication needs, confirmation that said patient is taking the medications according to instructions;
providing intervention if necessary to assure that said patient is complying with their medication regimen, monitoring both physical and psychological functions to detect early signs of adverse medication interactions or toxicity;
providing education to said patient and their care givers regarding the appropriate use of medications; and
providing data analysis. of the information obtained regarding each said patient.

37. The computer readable medium of claim 36, further comprising ordering an assessment of said patient's medication regimen by a physician, nurse practitioner, care giver, home healthcare agency or others concerned with said patient's welfare.

38. The computer readable medium of claim 36 further comprising performing a physical examination of said patient to determine said patient's medical condition.

39. The computer readable medium of claim 36 further comprising entering said assessment of said patient's medication regimen into a database.

40. The computer readable medium of claim 36 wherein said database is compliant with HIPPA regulations and access is restricted to individuals associated with said patient's well being or third parties with consent of the patient or the patient's guardians.

41. The computer readable medium of claim 36 wherein said assessment of said patient's medication regimen includes prescription medications, over the counter medications and herbal medications.

42. The computer readable medium of claim 36 wherein determining said patient's compliance with their medication regimen includes counting the pills remaining in a given medication prescription and comparing the results to the number of. pills that should be remaining in said prescription if said patient has been complying with their medication regimen.

43. The computer readable medium of claim 36 wherein determining said patient'compliance with their medication regimen includes asking the patient if they are complying with their medication regimen.

44. The computer readable medium of claim 36 wherein said assessment of said patient's medication regimen includes determining if there are any adverse interactions between the medications which said patient is taking.

45. The computer readable medium of claim 44 further determining if any of said adverse interactions can be tolerated by said patient.

46. The computer readable medium of claim 44 wherein after determining that an adverse interaction between medications is present, determining if there are alternate medications which can be substituted for the adverse interaction medication.

47. The computer readable medium of claim 36 further comprising conducting laboratory tests to determine if said patient still has the medical conditions which necessitated certain medication prescriptions.

48. The computer readable medium of claim 36 wherein said determination of said patient's compliance with their medication regimen includes writing a new prescription or refilling an existing prescription for a medication in said patient's medication regimen.

49. The computer readable medium of claim 36 further comprising determining said patient's daily living activities.

50. The computer readable medium of claim 49 wherein a notation is made in a database when a determination is made that an adverse condition is present in said patient's daily living activities.

51. The computer readable medium of claim 50 wherein an authorized individual can access said database, evaluate said adverse condition, and recommend a course of action to remove or correct said adverse condition.

52. The computer readable medium of claim 36 further including a psychological evaluation of said patient.
